(19) United States
(12) Patent Application Publication
(10) Pub. No.: US 2016/0050952 A1
(43) Pub. Date: Feb. 25, 2016

(54) ENVIRONMENTALLY SUSTAINABLE FRYING OILS

(71) Applicants: Susan Knowlton, Elkton, MD (US); Robin E. Jenkins, Cochranville, PA (US); Todd M. Krieger, Landenberg, PA (US)

(72) Inventors: Susan Knowlton, Elkton, MD (US); Robin E. Jenkins, Cochranville, PA (US); Todd M. Krieger, Landenberg, PA (US)

(21) Appl. No.: 14/412,602

(22) PCT Filed: Aug. 15, 2012
(86) PCT No.: PCT/US12/51005

§ 371 Date: Oct. 5, 2015

Related U.S. Application Data
(63) Continuation-in-part of application No. 13/541,084, filed on Jul. 3, 2012, now abandoned.

(51) Int. Cl. A23D 9/00; A23L 1/01

(52) U.S. Cl. CPC A23D 9/00; A23L 1/0107; A23V 2002/00

(57) ABSTRACT

This invention relates to environmentally preferred frying oils, such as high oleic oils. A Life Cycle Assessment (LCA) of high oleic oil compared to conventional oil when used in frying applications is provided.

### FIELD OF THE INVENTION

This invention relates to environmentally preferred frying oils, such as high oleic oils. A Life Cycle Assessment (LCA) of high oleic oil compared to conventional oil when used in frying applications is provided.

### BACKGROUND OF THE INVENTION

Life Cycle Assessment (LCA) is a scientific decision support tool which quantifies the potential environmental implications of a product or process, from raw materials extracted out of the ground through the end of life of that product. By including the impacts throughout the product life cycle, LCA provides a comprehensive view of the environmental aspects of the product or process and a more accurate picture of the true environmental trade-offs in product and process selection. The ISO 14040 standard series provides guidance on how to complete an LCA [ISO, 2006]. An LCA includes a specific goal and scope, accounting for the life cycle inventories of each step in the process, and then calculating the environmental impacts of interest. The last step in the LCA is interpreting the results.

Soybean oil is the most abundant vegetable oil in the world. Common soybean varieties produce an oil high in polyunsaturated fatty acids. This property makes the oil unstable, easily oxidized and subject to becoming rancid. When heated, soybean oil develops objectionable flavors and odors, making it unsuitable for many applications. Oils with high levels of polyunsaturated fatty acids are not often used in applications that require a high degree of oxidative stability, such as cooking for a long period of time at an elevated temperature.

The present disclosure generally relates to a sustainable frying oil which reduces the environmental impact and carbon footprint in the food service industry.

### SUMMARY OF THE INVENTION

In a first embodiment, the invention concerns an environmentally preferred frying oil, wherein said environmentally preferred frying oil has an increased oleic content when compared to an ordinary frying oil.

In a second embodiment, the invention concerns an environmentally preferred frying oil, wherein said environmentally preferred frying oil is useful as a blending source to make a blended environmentally preferred frying oil.

In a third embodiment, the invention concerns an environmentally preferred frying oil obtained from a high oleic oilseed. The oilseed is one selected from the group consisting of: soybean, palm, peanut, canola, sunflower, corn, flax, cotton, and safflower.

In a another embodiment, the invention concerns an environmentally preferred frying oil, wherein the oleic acid content of said oil comprises at least 60% of the fatty acid moieties in the oil.

In yet another embodiment, the invention concerns a method for frying with a reduced impact on the environment, comprising:
using an oil with an increased oleic acid content when compared to an ordinary oil.

A further embodiment of the invention concerns a method for frying with a reduced impact on the environment, comprising using an oil with an increased oleic acid content when compared to an ordinary oil and quantifying the reduction in environmental impacts when using a frying oil with an increased oleic acid content compared to an ordinary frying oil, wherein the reduction environmental impact is at least one selected from the group consisting of: reduced carbon footprint, reduced eutrophication potential, reduced air acidification potential, and reduced non-renewable energy consumption.

High oleic oil obtained from seeds, soybean, palm, peanut, canola, sunflower, corn, flax, cotton, and safflower are also part of the invention.

A further embodiment of the invention concerns the use of a high oleic oil, wherein the use of the oil for frying applications reduces land use pressure.

An additional embodiment of the invention concerns use of a high oleic frying oil for reduction of environmental impact, such as a reduction of carbon footprint, reduction of eutrophication potential, reduction of air acidification potential, or reduction of non-renewable energy consumption. A further embodiment of the invention includes the use of a high oleic oil for frying, wherein the burden on the environment is reduced by at least 40% when compared to the use of a conventional oil.

### BRIEF DESCRIPTION OF THE DRAWINGS AND SEQUENCE LISTINGS

The patent or application file contains at least one drawing executed in color. Copies of this patent or patent application publication with color drawing(s) will be provided by the Office upon request and payment of the necessary fee.

The invention can be more fully understood from the following detailed description and the accompanying drawings and Sequence Listing, which form a part of this application.

FIG. 1 shows the climate change potential of high oleic oil compared to conventional oil during a 2 day fryer use.

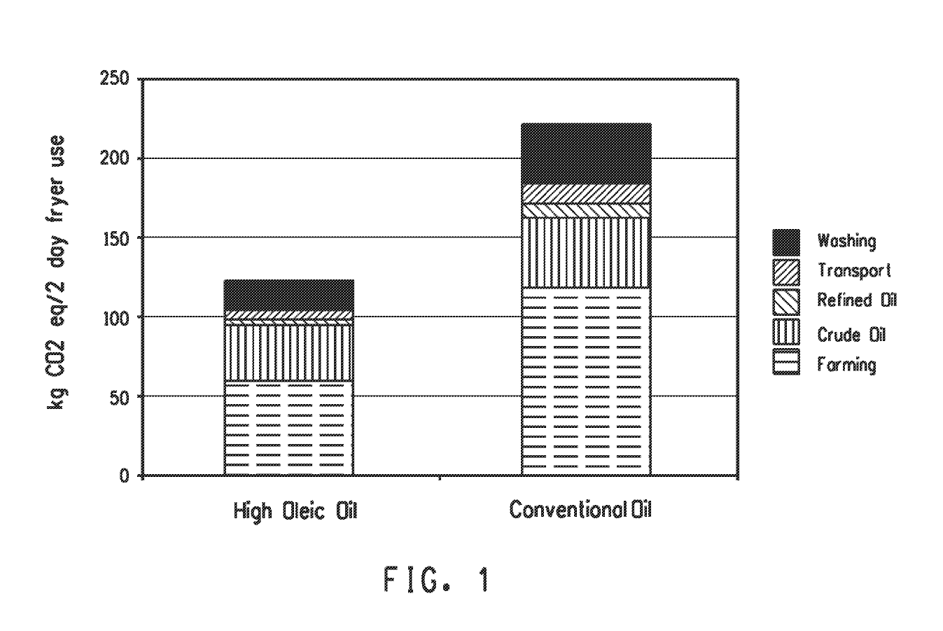

FIG. 2 shows the non-renewable energy use of high oleic oil compared to conventional oil during a 2 day fryer use.

FIG. 3 shows the terrestrial acidification potential of high oleic compared to conventional oil during a 2 day fryer use.

FIG. 4 shows freshwater eutrophication potential of high oleic compared to conventional oil during a 2 day fryer use.

FIG. 5 shows a comparison of conventional, high oleic soy oil base case soy oil, and high oleic high price premium soy oil and their relative impact on climate change potential, non-renewable energy use, terrestrial acidification potential, and freshwater eutrophication potential.

FIG. 6 shows a sensitivity analysis of the allocation method of high oleic and conventional oil on climate change potential.

FIG. 7 shows a sensitivity analysis of the allocation method of high oleic and conventional oil on terrestrial acidification potential.

FIG. 8 shows a comparison of conventional oil base case, conventional oil base case using a 2-day wash cycle, and high oleic oil and their relative impact on climate change potential, terrestrial acidification potential, freshwater eutrophication potential, and non-renewable energy use.

FIG. 9: shows the climate change potential per 2 day fryer use in restaurant for high oleic canola oil compared to conventional canola oil.

FIG. 10: shows the non-renewable energy use per 2 day fryer use in a restaurant for high oleic canola oil compared to conventional canola oil.

FIG. 11: Terrestrial acidification potential per 2 day fryer use in a restaurant for high oleic canola oil compared to conventional canola oil.

FIG. 12: Freshwater eutrophication potential per 2 day fryer use in a restaurant for high oleic canola oil compared to conventional canola oil.

FIG. 13: Flowchart: soybean oil life cycle system boundaries.

### DETAILED DESCRIPTION OF THE INVENTION

All patents, patent applications, and publications cited herein are incorporated by reference in their entirety.

In the context of this disclosure, a number of terms shall be utilized.

As used herein, “soybean” refers to the species Glycine max, Glycine soja, or any species that is sexually cross compatible with Glycine max. A “line” is a group of plants of similar parentage that display little or no genetic variation between individuals for a least one trait. Such lines may be created by one or more generations of self-pollination and selection, or vegetative propagation from a single parent including by tissue or cell culture techniques. An “agronomically elite line” or “elite line” refers to a line with desirable agronomic performance that may or may not be used commercially. A “variety”, “cultivar”, “elite variety”, or “elite cultivar” refers to an agronomically superior elite line that has been extensively tested and is or was being used for commercial soybean production. “Mutation” refers to a detectable and heritable genetic change (either spontaneous or induced) not caused by segregation or genetic recombination. “Mutant” refers to an individual, or lineage of individuals, possessing a mutation.

The environmental aspects of using high oleic oil in a large-scale restaurant fryer application were studied using life cycle assessment (LCA).

Life Cycle Assessment (LCA) is a scientific decision support tool which quantifies the potential environmental implications of a product or process, from raw materials extracted out of the ground through the end of life of that product. By including the impacts throughout the product life cycle, LCA provides a comprehensive view of the environmental aspects of the product or process and a more accurate picture of the true environmental trade-offs in product and process selection. The ISO 14040 standard series provides guidance on how to complete an LCA [ISO, 2006]. An LCA includes a specific goal and scope, accounting for the life cycle inventories of each step in the process, and then calculating the environmental impacts of interest. The last step in the LCA is interpreting the results.

The term “environmentally preferred” or “sustainable” means reduction in the impact on the environment, such as, but not limited to a reduction in at least one of the following parameters: carbon footprint, eutrophication potential, air acidification potential, and non-renewable energy consumption.

Climate Change Potential—according to the US Environmental Protection Agency, “Climate change refers to any significant change in the climate lasting for an extended period. Climate change can be caused by natural factors, natural processes, and human activities. Climate change potential (carbon footprint) is measured in terms of total greenhouse gas emissions, and takes into account the global warming potential of specific species known to contribute to climate change.

The term “Freshwater Eutrophication Potential” refers to the overload of a waterbody with nutrients. This overload causes an increase in algal growth and a subsequent reduction in oxygen availability for aquatic life. Freshwater eutrophication is caused by phosphorous-containing emissions.

The term “Terrestrial acidification potential” or “acid rain”—refers to emissions which alter optimum soil pH. The emissions that contribute to acidification are NOx, ammonia, and SO₂.

The term “Non-renewable energy use” or “fossile fuel depletion”—accounts for all of the coal, oil, natural gas, and uranium consumed in a particular supply chain.

The term “land use” refers to the exploitation of land for agricultural, industrial, residential, recreational, or other purposes.

In a first embodiment, the invention concerns an environmentally preferred frying oil, wherein said environmentally preferred frying oil has an increased oleic content when compared to an ordinary frying oil.

In a second embodiment, the invention concerns an environmentally preferred frying oil, wherein said environmentally preferred frying oil is useful as a blending source to make a blended environmentally preferred frying oil.

In a third embodiment, the invention concerns an environmentally preferred frying oil obtained from a high oleic oilseed. The oilseed is one selected from the group consisting of: soybean, palm, peanut, canola, sunflower, corn, flax, cotton, and safflower.

In a another embodiment, the invention concerns an environmentally preferred frying oil, wherein the oleic acid content of said oil comprises at least 60% of the fatty acid moieties in the oil.

In yet another embodiment, the invention concerns a method for frying with a reduced impact on the environment, comprising:

using an oil with an increased oleic acid content when compared to an ordinary oil.

A further embodiment of the invention concerns a method for frying with a reduced impact on the environment, comprising using an oil with an increased oleic acid content when compared to an ordinary oil and quantifying the reduction in environmental impacts when using a frying oil with an increased oleic acid content compared to an ordinary frying oil, wherein the reduction environmental impact is at least one selected from the group consisting of: reduced carbon footprint, reduced eutrophication potential, reduced air acidification potential, and reduced non-renewable energy consumption.

High oleic oil obtained from seeds, soybean, palm, peanut, canola, sunflower, corn, flax, cotton, and safflower are also part of the invention.

A further embodiment of the invention concerns the use of a high oleic oil, wherein the use of the oil for frying applications reduces land use pressure.

An additional embodiment of the invention concerns use of a high oleic frying oil for reduction of environmental impact, such as a reduction of carbon footprint, reduction of eutrophication potential, reduction of air acidification potential, or reduction of non-renewable energy consumption. A further embodiment of the invention includes the use of a high oleic oil for frying, wherein the burden on the environment is reduced by at least 40% when compared to the use of a conventional oil.

The term “fatty acids” refers to long-chain aliphatic acids (alkanoic acids) of varying chain length, from about C₁₂ to C₂₂ (although both longer and shorter chain-length acids are known). The predominant chain lengths are between C₁₆ and C₂₂. The structure of a fatty acid is represented by a simple notation system of “X:Y”, where X is the total number of C atoms in the particular fatty acid and Y is the number of double bonds.

Generally, fatty acids are classified as saturated or unsaturated. The term “saturated fatty acids” refers to those fatty acids that have no “double bonds” between their carbon backbone. In contrast, “unsaturated fatty acids” have “double bonds” along their carbon backbones (which are most commonly in the cis-configuration). “Monounsaturated fatty acids” have only one “double bond” along the carbon backbone (e.g., usually between the 9^{th} and 10^{th} carbon atom as for palmitoleic acid (16:1) and oleic acid (18:1)), while “polyunsaturated fatty acids” (or “PUFAs”) have at least two double bonds along the carbon backbone (e.g., between the 9^{th} and 10^{th}, and 12^{th} and 13^{th} carbon atoms for linoleic acid (18:2); and between the 9^{th} and 10^{th}, 12^{th} and 13^{th}, and 15^{th} and 16^{th} for α-linolenic acid (18:3)).

The term “total fatty acid content” refers to the sum of the five major fatty acid components found in soybeans, namely C16:0, C18:0, C18:1, C18:2, and C18:3. The term “total polyunsaturated fatty acid content” refers to the total C18:2 plus C18:3 content.

For the purposes of the present disclosure, the omega-reference system will be used to indicate the number of carbons, the number of double bonds and the position of the double bond closest to the omega carbon, counting from the omega carbon (which is the terminal carbon of the aliphatic chain and is numbered 1 for this purpose). This nomenclature is shown below in Table 1, in the column titled “Shorthand Notation”.

TABLE 1
Nomenclature of Polyunsaturated Fatty Acids

| | | | Shorthand |
|---|---|---|---|
| Common Name | Abbreviation | Chemical Name | Notation |
| Linoleic | LA | cis-9,12-octadecadienoic | 18:2 ω-6 |
| α-Linolenic | αLIN | cis-9,12,15- | 18:3 ω -3 |
| | | octadecatrienoic | |

The term “desaturase” refers to a polypeptide that can desaturate, i.e., introduce a double bond, in one or more fatty acids to produce a mono- or polyunsaturated fatty acid or precursor which is of interest. Despite use of the omega-reference system throughout the specification in reference to specific fatty acids, it is more convenient to indicate the activity of a desaturase by counting from the carboxyl end of the substrate using the A-system.

The terms “FAD” and fatty acid desaturase are used interchangeably and refer to membrane bound microsomal oleoyl- and linoleoyl-phosphatidylcholine desaturases that convert oleic acid to linoleic acid and linoleic acid to linolenic acid, respectively, in reactions that reduce molecular oxygen to water and require the presence of NADH.

The term “high oleic oilseed” refers to seeds that have an oleic acid content of at least 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, and 95% of the seed by weight. The high oleic oilseed can be one selected from the group consisting of: soybean, sunflower, palm, peanut, corn and canola. Preferred high oleic soybean oil starting materials are disclosed in World Patent Publication WO94/11516, the disclosure of which is hereby incorporated by reference.

The term high oleic oil refers to an oil that has at least 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, and 95% of its fatty acid moieties in the oleic acid.

The term “ordinary oil” or “conventional oil” refers to an oil obtained from commodity oilseeds, wherein the oleic acid content of said oil comprises less than 30%, 29%, 28%, 27%, 26%, 25%, 24%, 23% 22%, 21%, 20%, 19%, 18%, 17%, 16%, 15%, 14%, 13%, 12%, 11%, 10%, 9%, 8%, 7%, 6%, 5%, 4%, 3%, 2%, 1% of the fatty acid moieties in the oil.

The term enzyme “activity” refers to the ability of an enzyme to convert a substrate to a product.

The terms “polynucleotide”, “polynucleotide sequence”, “nucleic acid sequence”, “nucleic acid fragment”, and “isolated nucleic acid fragment” are used interchangeably herein. These terms encompass nucleotide sequences and the like. A polynucleotide may be a polymer of RNA or DNA that is single- or double-stranded, that optionally contains synthetic, non-natural or altered nucleotide bases. A polynucleotide in the form of a polymer of DNA may be comprised of one or more segments of cDNA, genomic DNA, synthetic DNA, or mixtures thereof. Nucleotides (usually found in their 5′-monophosphate form) are referred to by a single letter designation as follows: “A” for adenylate or deoxyadenylate (for RNA or DNA, respectively), “C” for cytidylate or deoxycytidylate, “G” for guanylate or deoxyguanylate, “U” for uridylate, “T” for deoxythymidylate, “R” for purines (A or G), “Y” for pyrimidines (C or T), “K” for G or T, “H” for A or C or T, “I” for inosine, and “N” for any nucleotide.

The terms “subfragment that is functionally equivalent” and “functionally equivalent subfragment” are used interchangeably herein. These terms refer to a portion or subsequence of an isolated nucleic acid fragment in which the ability to alter gene expression or produce a certain phenotype is retained whether or not the fragment or subfragment encodes an active enzyme. For example, the fragment or subfragment can be used in the design of chimeric genes to produce the desired phenotype in a transformed plant.

Chimeric genes can be designed for use in suppression by linking a nucleic acid fragment or subfragment thereof, whether or not it encodes an active enzyme, in the sense or antisense orientation relative to a plant promoter sequence.

The terms “homology”, “homologous”, “substantially similar” and “corresponding substantially” are used interchangeably herein. They refer to nucleic acid fragments wherein changes in one or more nucleotide bases do not affect the ability of the nucleic acid fragment to mediate gene expression or produce a certain phenotype. These terms also refer to modifications of the nucleic acid fragments of the instant invention such as deletion or insertion of one or more nucleotides that do not substantially alter the functional properties of the resulting nucleic acid fragment relative to the initial, unmodified fragment. It is therefore understood, as those skilled in the art will appreciate, that the invention encompasses more than the specific exemplary sequences.

“Gene” refers to a nucleic acid fragment that expresses a specific protein, including regulatory sequences preceding (5′ non-coding sequences) and following (3′ non-coding sequences) the coding sequence. “Native gene” refers to a gene as found in nature with its own regulatory sequences. “Chimeric gene” refers to any gene that is not a native gene, comprising regulatory and coding sequences that are not found together in nature. Accordingly, a chimeric gene may comprise regulatory sequences and coding sequences that are derived from different sources, or regulatory sequences and coding sequences derived from the same source, but arranged in a manner different than that found in nature. A “foreign” gene refers to a gene not normally found in the host organism, but that is introduced into the host organism by gene transfer. Foreign genes can comprise native genes inserted into a non-native organism, or chimeric genes. A “transgene” is a gene that has been introduced into the genome by a transformation procedure. An “allele” is one of several alternative forms of a gene occupying a given locus on a chromosome. When all the alleles present at a given locus on a chromosome are the same that plant is homozygous at that locus. If the alleles present at a given locus on a chromosome differ that plant is heterozygous at that locus. A “codon-optimized gene” is a gene having its frequency of codon usage designed to mimic the frequency of preferred codon usage of the host cell.

“Coding sequence” refers to a DNA sequence that codes for a specific amino acid sequence. “Regulatory sequences” refer to nucleotide sequences located upstream (5′ non-coding sequences), within, or downstream (3′ non-coding sequences) of a coding sequence, and which influence the transcription, RNA processing or stability, or translation of the associated coding sequence. Regulatory sequences may include, but are not limited to, promoters, translation leader sequences, introns, and polyadenylation recognition sequences.

“Promoter” refers to a region of DNA capable of controlling the expression of a coding sequence or functional RNA. The promoter sequence consists of proximal and more distal upstream elements. These upstream elements are often referred to as enhancers. Accordingly, an “enhancer” is a DNA sequence that can stimulate promoter activity, and may be an innate element of the promoter or a heterologous element inserted to enhance the level or tissue-specificity of a promoter. Promoters may be derived in their entirety from a native gene, or be composed of different elements derived from different promoters found in nature, or even comprise synthetic DNA segments. It is understood by those skilled in the art that different promoters may direct the expression of a gene in different tissues or cell types, or at different stages of development, or in response to different environmental conditions. It is further recognized that since in most cases the exact boundaries of regulatory sequences have not been completely defined, DNA fragments of some variation may have identical promoter activity. Promoters that cause a gene to be expressed in most cell types at most times are commonly referred to as “constitutive promoters”. New promoters of various types useful in plant cells are constantly being discovered; numerous examples may be found in the compilation by Okamuro and Goldberg (1989) Biochemistry of Plants 15:1-82.

Any seed-specific promoter can be used in accordance with the method of the invention. Thus, the origin of the promoter chosen to drive expression of the recombinant DNA fragment is not critical as long as it is capable of accomplishing the invention by transcribing enough RNA from the desired nucleic acid fragment(s) in the seed.

A plethora of promoters is described in WO 00/18963, published on Apr. 6, 2000, the disclosure of which is hereby incorporated by reference. Examples of seed-specific promoters include, and are not limited to, the promoter for soybean Kunitz trypsin inhibitor (Kti3, Jofuku and Goldberg (1989) Plant Cell 1:1079-1093) β-conglycinin (Chen et al. (1989) Dev. Genet. 10: 112-122), the napin promoter, and the phaseolin promoter.

Specific examples of promoters that may be useful in expressing the nucleic acid fragments of the invention include, but are not limited to, the SAM synthetase promoter (PCT Publication WO00/37662, published Jun. 29, 2000), the CaMV 35S (Odell et al (1985) Nature 313:810-812), and the promoter described in PCT Publication WO02/099063 published Dec. 12, 2002.

The “translation leader sequence” refers to a polynucleotide sequence located between the promoter sequence of a gene and the coding sequence. The translation leader sequence is present in the fully processed mRNA upstream of the translation start sequence. The translation leader sequence may affect processing of the primary transcript to mRNA, mRNA stability or translation efficiency. Examples of translation leader sequences have been described (Turner and Foster (1995) Mol. Biotechnol. 3:225-236).

The “3′ non-coding sequences” or “transcription terminator/termination sequences” refer to DNA sequences located downstream of a coding sequence and include polyadenylation recognition sequences and other sequences encoding regulatory signals capable of affecting mRNA processing or gene expression. The polyadenylation signal is usually characterized by affecting the addition of polyadenylic acid tracts to the 3′ end of the mRNA precursor. The use of different 3′non-coding sequences is exemplified by Ingelbrecht et al. (1989) Plant Cell 1:671-680.

An “intron” is an intervening sequence in a gene that does not encode a portion of the protein sequence. Thus, such sequences are transcribed into RNA but are then excised and are not translated. The term is also used for the excised RNA sequences. An “exon” is a portion of the sequence of a gene that is transcribed and is found in the mature messenger RNA derived from the gene, but is not necessarily a part of the sequence that encodes the final gene product.

“RNA transcript” refers to the product resulting from RNA polymerase-catalyzed transcription of a DNA sequence. When the RNA transcript is a perfect complementary copy of the DNA sequence, it is referred to as the primary transcript. An RNA transcript is referred to as the mature RNA when it is an RNA sequence derived from post-transcriptional processing of the primary transcript. “Messenger RNA (mRNA)” refers to the RNA that is without introns and that can be translated into protein by the cell. “cDNA” refers to a DNA that is complementary to and synthesized from a mRNA template using the enzyme reverse transcriptase. The cDNA can be single-stranded or converted into the double-stranded form using the Klenow fragment of DNA polymerase I. “Sense” RNA refers to RNA transcript that includes the mRNA and can be translated into protein within a cell or in vitro. “Antisense RNA” refers to an RNA transcript that is complementary to all or part of a target primary transcript or mRNA, and that blocks the expression of a target gene (U.S. Pat. No. 5,107,065). The complementarity of an antisense RNA may be with any part of the specific gene transcript, i.e., at the 5′ non-coding sequence, 3′ non-coding sequence, introns, or the coding sequence. “Functional RNA” refers to antisense RNA, ribozyme RNA, or other RNA that may not be translated but yet has an effect on cellular processes. The terms “complement” and “reverse complement” are used interchangeably herein with respect to mRNA transcripts, and are meant to define the antisense RNA of the message.

The term “operably linked” refers to the association of nucleic acid sequences on a single nucleic acid fragment so that the function of one is regulated by the other. For example, a promoter is operably linked with a coding sequence when it is capable of regulating the expression of that coding sequence (i.e., that the coding sequence is under the transcriptional control of the promoter). Coding sequences can be operably linked to regulatory sequences in a sense or antisense orientation. In another example, the complementary RNA regions of the invention can be operably linked, either directly or indirectly, 5′ to the target mRNA, or 3′ to the target mRNA, or within the target mRNA, or a first complementary region is 5′ and its complement is 3′ to the target mRNA.

The term “endogenous RNA” refers to any RNA which is encoded by any nucleic acid sequence present in the genome of the host prior to transformation with the recombinant construct of the present invention, whether naturally-occurring or non-naturally occurring, i.e., introduced by recombinant means, mutagenesis, etc.

The term “non-naturally occurring” means artificial, not consistent with what is normally found in nature.

Standard recombinant DNA and molecular cloning techniques used herein are well known in the art and are described more fully in Sambrook et al., Molecular Cloning: A Laboratory Manual; Cold Spring Harbor Laboratory Press: Cold Spring Harbor, 1989. Transformation methods are well known to those skilled in the art and are described below.

“PCR” or “Polymerase Chain Reaction” is a technique for the synthesis of large quantities of specific DNA segments, consists of a series of repetitive cycles (Perkin Elmer Cetus Instruments, Norwalk, Conn.). Typically, the double stranded DNA is heat denatured, the two primers complementary to the 3′ boundaries of the target segment are annealed at low temperature and then extended at an intermediate temperature. One set of these three consecutive steps is referred to as a cycle.

The term “recombinant” refers to an artificial combination of two otherwise separated segments of sequence, e.g., by chemical synthesis or by the manipulation of isolated segments of nucleic acids by genetic engineering techniques.

The terms “plasmid”, “vector” and “cassette” refer to an extra chromosomal element often carrying genes that are not part of the central metabolism of the cell, and usually in the form of circular double-stranded DNA fragments. Such elements may be autonomously replicating sequences, genome integrating sequences, phage or nucleotide sequences, linear or circular, of a single- or double-stranded DNA or RNA, derived from any source, in which a number of nucleotide sequences have been joined or recombined into a unique construction which is capable of introducing a promoter fragment and DNA sequence for a selected gene product along with appropriate 3′untranslated sequence into a cell. “Transformation cassette” refers to a specific vector containing a foreign gene and having elements in addition to the foreign gene that facilitates transformation of a particular host cell. “Expression cassette” refers to a specific vector containing a foreign gene and having elements in addition to the foreign gene that allow for enhanced expression of that gene in a foreign host.

The terms “recombinant construct”, “expression construct”, “chimeric construct”, “construct”, and “recombinant DNA construct” are used interchangeably herein. A recombinant construct comprises an artificial combination of nucleic acid fragments, e.g., regulatory and coding sequences that are not found together in nature. For example, a chimeric construct may comprise regulatory sequences and coding sequences that are derived from different sources, or regulatory sequences and coding sequences derived from the same source, but arranged in a manner different than that found in nature. Such construct may be used by itself or may be used in conjunction with a vector. If a vector is used then the choice of vector is dependent upon the method that will be used to transform host cells as is well known to those skilled in the art. For example, a plasmid vector can be used. The skilled artisan is well aware of the genetic elements that must be present on the vector in order to successfully transform, select and propagate host cells comprising any of the isolated nucleic acid fragments of the invention. The skilled artisan will also recognize that different independent transformation events will result in different levels and patterns of expression (Jones et al., (1985) EMBO J. 4:2411-2418; De Almeida et al., (1989) Mol. Gen. Genetics 218:78-86), and thus that multiple events must be screened in order to obtain lines displaying the desired expression level and pattern. Such screening may be accomplished by Southern analysis of DNA, Northern analysis of mRNA expression, immunoblotting analysis of protein expression, or phenotypic analysis, among others.

The term “expression”, as used herein, refers to the production of a functional end-product e.g., a mRNA or a protein (precursor or mature).

The term “expression cassette” as used herein, refers to a discrete nucleic acid fragment into which a nucleic acid sequence or fragment can be moved.

“Mature” protein refers to a post-translationally processed polypeptide; i.e., one from which any pre- or propeptides present in the primary translation product have been removed. “Precursor” protein refers to the primary product of translation of mRNA; i.e., with pre- and propeptides still present. Pre- and propeptides may be but are not limited to intracellular localization signals.

“Cosuppression” refers to the production of sense RNA transcripts capable of suppressing the expression of identical or substantially similar native genes (U.S. Pat. No. 5,231,020, which issued to Jorgensen et al. on Jul. 27, 1999). Cosuppression constructs in plants have been previously designed by focusing on overexpression of a nucleic acid sequence having homology to a native mRNA, in the sense orientation, which results in the reduction of all RNA having homology to the overexpressed sequence (see Vaucheret et al. (1998) Plant J. 16:651-659; and Gura (2000) Nature 404:804-808). “Antisense inhibition” refers to the production of antisense RNA transcripts capable of suppressing the expression of the target protein. Plant viral sequences may be used to direct the suppression of proximal mRNA encoding sequences (PCT Publication WO 98/36083 published on Aug. 20, 1998). “Hairpin” structures that incorporate all, or part, of an mRNA encoding sequence in a complementary orientation resulting in a potential “stem-loop” structure for the expressed RNA have been described (PCT Publication WO 99/53050 published on Oct. 21, 1999). In this case the stem is formed by polynucleotides corresponding to the gene of interest inserted in either sense or anti-sense orientation with respect to the promoter and the loop is formed by some polynucleotides of the gene of interest, which do not have a complement in the construct. This increases the frequency of cosuppression or silencing in the recovered transgenic plants. For review of hairpin suppression see Wesley et al. (2003) Methods in Molecular Biology, Plant Functional Genomics: Methods and Protocols 236:273-286. A construct where the stem is formed by at least 30 nucleotides from a gene to be suppressed and the loop is formed by a random nucleotide sequence has also effectively been used for suppression (WO 99/61632 published on Dec. 2, 1999). The use of poly-T and poly-A sequences to generate the stem in the stem-loop structure has also been described (WO 02/00894 published Jan. 3, 2002). Yet another variation includes using synthetic repeats to promote formation of a stem in the stem-loop structure. Transgenic organisms prepared with such recombinant DNA fragment show reduced levels of the protein encoded by the polynucleotide from which the nucleotide fragment forming the loop is derived as described in PCT Publication WO 02/00904, published Jan. 3, 2002. The use of constructs that result in dsRNA has also been described. In these constructs convergent promoters direct transcription of gene-specific sense and antisense RNAs inducing gene suppression (see for example Shi et al. (2000) RNA 6:1069-1076; Bastin et al. (2000) J. Cell Sci. 113:3321-3328; Giordano et al. (2002) Genetics 160:637-648; LaCount and Donelson US patent Application No. 20020182223, published Dec. 5, 2002; Tran et al. (2003) BMC Biotechnol. 3:21; and Applicant's U.S. Provisional Application No. 60/578,404, filed Jun. 9, 2004).

Other methods for suppressing an enzyme include, but are not limited to, use of polynucleotides that may form a catalytic RNA or may have ribozyme activity (U.S. Pat. No. 4,987,071 issued Jan. 22, 1991), and micro RNA (also called miRNA) interference (Javier et al. (2003) Nature 425:257-263).

MicroRNAs (miRNA) are small regulatory RNAs that control gene expression. miRNAs bind to regions of target RNAs and inhibit their translation and, thus, interfere with production of the polypeptide encoded by the target RNA. miRNAs can be designed to be complementary to any region of the target sequence RNA including the 3′ untranslated region, coding region, etc. miRNAs are processed from highly structured RNA precursors that are processed by the action of a ribonuclease III termed DICER. While the exact mechanism of action of miRNAs is unknown, it appears that they function to regulate expression of the target gene. See, e.g., U.S. Patent Publication No. 2004/0268441 A1 which was published on Dec. 30, 2004.

The term “expression”, as used herein, refers to the production of a functional end-product, be it mRNA or translation of mRNA into a polypeptide.

“Antisense inhibition” refers to the production of antisense RNA transcripts capable of suppressing the expression of the target protein. “Co-suppression” refers to the production of sense RNA transcripts capable of suppressing the expression of identical or substantially similar foreign or endogenous genes (U.S. Pat. No. 5,231,020).

“Overexpression” refers to the production of a functional end-product in transgenic organisms that exceeds levels of production when compared to expression of that functional end-product in a normal, wild type or non-transformed organism.

“Stable transformation” refers to the transfer of a nucleic acid fragment into a genome of a host organism, including both nuclear and organellar genomes, resulting in genetically stable inheritance. In contrast, “transient transformation” refers to the transfer of a nucleic acid fragment into the nucleus, or DNA-containing organelle, of a host organism resulting in gene expression without integration or stable inheritance. Host organisms containing the transformed nucleic acid fragments are referred to as “transgenic” organisms.

Standard recombinant DNA and molecular cloning techniques used herein are well known in the art and are described by Sambrook et al., Molecular Cloning: A Laboratory Manual, 2nd ed., Cold Spring Harbor Laboratory: Cold Spring Harbor, N.Y. (1989); by Silhavy et al., Experiments with Gene Fusions, Cold Spring Harbor Laboratory: Cold Spring Harbor, N.Y. (1984); and by Ausubel et al., Current Protocols in Molecular Biology, published by Greene Publishing Assoc. and Wiley-Interscience (1987). Once the recombinant construct has been made, it may then be introduced into a plant cell or yeast cell of choice by methods well known to those of ordinary skill in the art including, for example, transfection, transformation and electroporation (see below). Oilseed plant cells are the preferred plant cells. The transformed plant cell is then cultured and regenerated under suitable conditions permitting expression of the recombinant construct which is then recovered and purified.

Recombinant constructs may be introduced into one plant cell or, alternatively, a construct may be introduced into separate plant cells.

Expression in a plant cell may be accomplished in a transient or stable fashion as is described above.

Plant parts include differentiated and undifferentiated tissues, including but not limited to: roots, stems, shoots, leaves, pollen, seeds, tumor tissue, and various forms of cells and culture such as single cells, protoplasts, embryos, and callus tissue. The plant tissue may be in plant or in organ, tissue or cell culture.

The term “plant organ” refers to plant tissue or group of tissues that constitute a morphologically and functionally distinct part of a plant. The term “genome” refers to the following: 1. The entire complement of genetic material (genes and non-coding sequences) is present in each cell of an organism, or virus or organelle. 2. A complete set of chromosomes inherited as a (haploid) unit from one parent. The term “stably integrated” refers to the transfer of a nucleic acid fragment into the genome of a host organism or cell resulting in genetically stable inheritance.

Methods for transforming dicots, primarily by use of Agrobacterium tumefaciens, and obtaining transgenic plants have been published, among others, for cotton (U.S. Pat. No. 5,004,863, U.S. Pat. No. 5,159,135); soybean (U.S. Pat. No. 5,569,834, U.S. Pat. No. 5,416,011); Brassica (U.S. Pat. No. 5,463,174); peanut (Cheng et al. (1996) Plant Cell Rep. 15:653-657, McKently et al. (1995) Plant Cell Rep. 14:699-703); papaya (Ling et al. (1991) Bio/technology 9:752-758); and pea (Grant et al. (1995) Plant Cell Rep. 15:254-258). For a review of other commonly used methods of plant transformation see Newell (2000) Mol. Biotechnol. 16:53-65. One of these methods of transformation uses Agrobacterium rhizogenes (Tepfler, and Casse-Delbart (1987) Microbiol. Sci. 4:24-28). Transformation of soybeans using direct delivery of DNA has been published using PEG fusion (PCT publication WO 92/17598), electroporation (Chowrira et al. (1995) Mol. Biotechnol. 3:17-23; Christou et al. (1987) Proc. Natl. Acad. Sci. U.S.A. 84:3962-3966), microinjection, or particle bombardment (McCabe et. al. (1988) Bio/Technology 6:923; Christou et al. (1988) Plant Physiol. 87:671-674).

There are a variety of methods for the regeneration of plants from plant tissue. The particular method of regeneration will depend on the starting plant tissue and the particular plant species to be regenerated. The regeneration, development and cultivation of plants from single plant protoplast transformants or from various transformed explants is well known in the art (Weissbach and Weissbach, (1988) In.: Methods for Plant Molecular Biology, (Eds.), Academic: San Diego, Calif.). This regeneration and growth process typically includes the steps of selection of transformed cells, culturing those individualized cells through the usual stages of embryonic development through the rooted plantlet stage. Transgenic embryos and seeds are similarly regenerated. The resulting transgenic rooted shoots are thereafter planted in an appropriate plant growth medium such as soil. Preferably, the regenerated plants are self-pollinated to provide homozygous transgenic plants. Otherwise, pollen obtained from the regenerated plants is crossed to seed-grown plants of agronomically important lines. Conversely, pollen from plants of these important lines is used to pollinate regenerated plants. A transgenic plant of the present invention containing a desired polypeptide is cultivated using methods well known to one skilled in the art.

In addition to the above discussed procedures, practitioners are familiar with the standard resource materials which describe specific conditions and procedures for the construction, manipulation and isolation of macromolecules (e.g., DNA molecules, plasmids, etc.), generation of recombinant DNA fragments and recombinant expression constructs and the screening and isolating of clones, (see for example, Sambrook et al. (1989) Molecular Cloning: A Laboratory Manual, Cold Spring Harbor: NY; Maliga et al. (1995) Methods in Plant Molecular Biology, Cold Spring Harbor: NY; Birren et al. (1998) Genome Analysis: Detecting Genes, 1, Cold Spring Harbor: NY; Birren et al. (1998) Genome Analysis: Analyzing DNA, 2, Cold Spring Harbor: NY; Plant Molecular Biology: A Laboratory Manual, eds. Clark, Springer: NY (1997)).

Oxidation and therefore the shelf life of animal feed ingredients is a common problem in the industry. Oxidation is an irreversible chemical reaction in which oxygen reacts with feed and feed components and can result in decreased animal health and performance. The negative effects of oxidation can be seen in loss of palatability, degradation of the oil component, development of unwanted breakdown products, changes in color, and loss of energy. Meat obtained from animals grown on oxidized feed has significantly lower oxidative status compared to animals fed a feed that has not undergone significant oxidation. Meat from animals fed diets containing high oleic corn products show extended shelf life and greater oxidative stability (PCT Publication WO/2006/002052, published Jan. 5, 2006), particularly when combined with antioxidants such as tocols. Therefore it is highly desirable to prevent oxidation of feed and feed ingredients to protect both nutritional value and organoleptic quality.

Synthetic antioxidants are used to preserve feed quality by preventing the oxidation of lipids, which can lead to improved animal performance. Generally, synthetic antioxidants can act as free radical scavengers and thereby reduce lipid oxidation. Synthetic antioxidants can prolong animal feed shelf-life and protect nutritional and organoleptic quality

There are multiple methods to test the oxidation status of solid materials including soybean meal and other soybean protein products including accelerating aging methods which predict a material's shelf-life. One test which can be used is to age a material either at room temperature or elevated temperatures and to measure the oxidative status of the material at specific time points. The OSI instrument is useful in this regard in that it reflects the length of time needed to start the oxidation process known as the induction time. A longer induction time means that the material has greater oxidative stability and thereby shelf-life. Other methods include the measurement of volatiles and color change.

Methods for obtaining soy protein products are well known to those skilled in the art. For example soybean protein products can be obtained in a variety of ways. Conditions typically used to prepare soy protein isolates have been described by (Cho, et al, (1981) U.S. Pat. No. 4,278,597; Goodnight, et al. (1978) U.S. Pat. No. 4,072,670). Soy protein concentrates are produced by three basic processes: acid leaching (at about pH 4.5), extraction with alcohol (about 55-80%), and denaturing the protein with moist heat prior to extraction with water. Conditions typically used to prepare soy protein concentrates have been described by Pass ((1975) U.S. Pat. No. 897,574) and Campbell et al. ((1985) in New Protein Foods, ed. by Altschul and Wilcke, Academic Press, Vol., Chapter 10, Seed Storage Proteins, pp 302-338).

“Soybean-containing products” or “Soy products” can be defined as those products containing/incorporating a soy protein product.

For example, “soy protein products” can include, and are not limited to, those items listed in Table 2.

TABLE 2
Soy Protein Products Derived from Soybean Seeds^{a}

Whole Soybean Products
Roasted Soybeans
Baked Soybeans
Soy Sprouts
Soy Milk
Specialty Soy Foods/Ingredients
Soy Milk
Tofu
Tempeh
Miso
Soy Sauce
Hydrolyzed Vegetable Protein
Whipping Protein
Processed Soy Protein Products
Full Fat and Defatted Flours
Soy Grits
Soy Hypocotyls
Soybean Meal
Soy Milk
Soy Protein Isolates
Soy Protein Concentrates
Textured Soy Proteins
Textured Flours and Concentrates
Textured Concentrates
Textured Isolates
^{a}See Soy Protein Products: Characteristics, Nutritional Aspects and Utilization (1987). Soy Protein Council.

“Processing” refers to any physical and chemical methods used to obtain the products listed in Table 2 and includes, and is not limited to, heat conditioning, flaking and grinding, extrusion, solvent extraction, or aqueous soaking and extraction of whole or partial seeds. Furthermore, “processing” includes the methods used to concentrate and isolate soy protein from whole or partial seeds, as well as the various traditional Oriental methods in preparing fermented soy food products. Trading Standards and Specifications have been established for many of these products (see National Oilseed Processors Association Yearbook and Trading Rules 1991-1992).

Defatted flakes refer to flaked, dehulled cotyledons that have been defatted and treated with controlled heat to remove the remaining hexane. This term can also refer to a flour or grit that has been ground.

“White” flakes refer to flaked, dehulled cotyledons that have been defatted and treated with controlled heat to remove the remaining hexane. This term can also refer to a flour that has been ground.

“Grits” refer to defatted, dehulled cotyledons having a U.S. Standard screen size of between No. 10 and 80.

“Soy Protein Concentrates” refer to those products produced from dehulled, defatted soybeans and typically contain 65 wt % to 90 wt % soy protein on a moisture free basis. Soy protein concentrates are typically manufactured by three basic processes: acid leaching (at about pH 4.5), extraction with alcohol (about 55-80%), and denaturing the protein with moist heat prior to extraction with water. Conditions typically used to prepare soy protein concentrates have been described by Pass (1975) U.S. Pat. No. 3,897,574; Campbell et al., (1985) in New Protein Foods, ed. by Altschul and Wilcke, Academic Press, Vol. 5, Chapter 10, Seed Storage Proteins, pp 302-338).

As used herein, the term “soy protein isolate” or “isolated soy protein” refers to a soy protein containing material that contains at least 90% soy protein by weight on a moisture free basis.

“Extrusion” refers to processes whereby material (grits, flour or concentrate) is passed through a jacketed auger using high pressures and temperatures as a means of altering the texture of the material. “Texturing” and “structuring” refer to extrusion processes used to modify the physical characteristics of the material. The characteristics of these processes, including thermoplastic extrusion, have been described previously (Atkinson (1970) U.S. Pat. No. 3,488,770, Horan (1985) In New Protein Foods, ed. by Altschul and Wilcke, Academic Press, Vol. 1A, Chapter 8, pp 367-414). Moreover, conditions used during extrusion processing of complex foodstuff mixtures that include soy protein products have been described previously (Rokey (1983) Feed Manufacturing Technology III, 222-237; McCulloch, U.S. Pat. No. 4,454,804).

Residual fatty acid analysis. The commercial process used to de-fat soy flakes with hexane leaves a residue of fatty acids that can act as substrate for generation of off-flavor compounds. Depending on the method of analysis, the residual fat content of hexane-defatted soy flakes can range from, 0.6-1.0% (W:W) (ether extractable; AOCS Method 920.39 (Official Methods of Analysis of the AOAC International (1995), 16^{th} Edition, Method 920.39C, Locator #4.2.01 (modified)) to 2.5-3% (W:W) (acid hydrolysable; AOAC Method 922.06 (Official Methods of Analysis of the AOAC International (1995), 16^{th} Edition, Method 922.06, Locator 32.1.13 (modified)). The principle reason for the discrepancy between these two methods of estimating residual fatty acids is the chemical nature of the fat classes associated with the protein matrix after hexane extraction. A small proportion of the residual fatty acid is in the form of neutral lipid (i.e., triglyceride) and the remainder is present as polar lipid (e.g., phospholipids, a.k.a., lecithin). Because of its polar nature the phospholipid is inaccessible to ether extraction and is only removed from the protein matrix if acid hydrolysis or some other stringent extraction protocol is performed. Therefore, the ether extraction technique gives an estimation of the neutral lipid fraction whereas the acid hydrolysable method gives a better estimate of the total residual fatty acid content (i.e., neutral and polar fractions).

Both of the AOAC methods described above rely on gravimetric determinations of the residual fatty acids and, although in combination they give an indication of the fat classes (neutral vs. polar), such estimates are crude and are subject to interference from other hydrophobic materials (e.g. saponins). Further, no information is obtained on the fatty acid composition and how it may have been affected by various experimental treatments or by the genetics of the starting material. AOAC methods for the determination of the fatty acid composition of residual fatty acids are available (Official Methods of Analysis of the AOAC International (2000), 17^{th} Edition, Method 983.23 Locator 45.4.02, Method 969.33 Locator 41.1.28, Method 996.06 Locator 41.1.28A). These are based on the conversion of residual fatty acids, extracted by acid hydrolysis, to fatty acid methyl esters prior to analysis by gas chromatography. Such techniques are rarely used to assess the residual fatty acid content of food materials in commercial settings although they are used for fatty acid evaluations in support of nutritional labeling. A report in which these methods have been used to determine the residual fatty acid composition of commercial soy protein isolates has recently been published (Solina et al. (2005) Volatile aroma components of soy protein isolate and acid-hydrolysed vegetable protein Food Chemistry 90: 861-873)

A facile method for determining the fatty acid composition of the residual fats in soy protein products is described in Example 24. The advantage of this method over others is that it requires no extraction of the residual fats from the matrix prior to derivatization for GC analysis. Further, the technique is suitable for all forms of fatty acids i.e., whether they are initially present as free fatty acids or as fatty acid esters e.g., tri-glycerides or phospholipids (Chistie (1989) Gas Chromatography and Lipids; The Oily Press. Ayr, Scotland). The technique will also remove fatty acids from the protein matrix even if the polar head group of the phospholipid is covalently bound to the protein.

Also, within the scope of this invention are food, food supplements, food bars, and beverages as well as animal feed (such as pet foods) that have incorporated therein a soybean protein product of the invention. The beverage can be in a liquid or in a dry powdered form.

The foods to which the soybean protein product of the invention can be incorporated/added include almost all foods, beverages and feed (such as pet foods). For example, there can be mentioned food supplements, food bars, meats such as meat alternatives, ground meats, emulsified meats, marinated meats, and meats injected with a soybean protein product of the invention. Included may be beverages such as nutritional beverages, sports beverages, protein-fortified beverages, juices, milk, milk alternatives, and weight loss beverages. Mentioned may also be cheeses such as hard and soft cheeses, cream cheese, and cottage cheese. Included may also be frozen desserts such as ice cream, ice milk, low fat frozen desserts, and non-dairy frozen desserts. Finally, yogurts, soups, puddings, bakery products, salad dressings, spreads, and dips (such as mayonnaise and chip dips) may be included.

A soy protein product can be added in an amount selected to deliver a desired amount to a food and/or beverage. The terms “soybean protein product” and “soy protein product” are used interchangeably herein.

Any high oleic soybean seed, whether transgenic or non-transgenic, can be used as a source of soy protein product.

Soybeans with decreased levels of saturated fatty acids have been described resulting from mutation breeding (Erickson et al. (1994) J. Hered. 79:465-468; Schnebly et al. (1994) Crop Sci. 34:829-833; and Fehr et al. (1991) Crop Sci. 31:88-89) and transgenic modification (U.S. Pat. No. 5,530,186). Soybeans with decreased levels of polyunsaturated fatty acids have been described resulting from mutation breeding and selection. Reduced levels of linolenic acid have been achieved at relatively constant linoleic acid (U.S. Pat. No. 5,710,369 and U.S. Pat. No. 5,986,118). Decreased linoleic and linolenic acids combined have also been achieved using mutation breeding, genetic crosses and selection (Rahman, S. M. et al. (2001) Crop Sci. 41:26-29). These methods produced soybean seeds with oil profiles having linolenic acid contents of from 1% to 3% of the total fatty acids and total levels of polyunsaturated fatty acids of about 30 to 35% as compared to greater than 6% linolenic acid and greater than 50% total polyunsaturated fatty acids in commodity soybeans.

The discovery of a method for altering the expression of the enzymes responsible for introduction of the second (international patent publication WO 94/11516) and third (international patent publication WO 93/11245) double bonds into soybean seed storage lipid in a directed manner has allowed the production of soybeans with a high mono-unsaturated, very low polyunsaturated fatty acid content and especially a very low linolenic acid content. The genetic combination of these two transgene profiles described in U.S. Pat. No. 6,426,448 leads to a soybean line with minimal poly-unsaturates and high mono-unsaturates and extreme environmental stability of the seed fatty acid profile.

The gene for microsomal delta-12 fatty acid desaturases described in WO 94/11516, can be used to make a high oleic acid soybean variety. The resulting high oleic acid soybean variety was one in which the polyunsaturated fatty acids were reduced from 70% of the total fatty acids to less than 5%.

Two soybean fatty acid desaturases, designated FAD2-1 and FAD2-2, are Δ-12 desaturases that introduce a second double bond into oleic acid to form linoleic acid, a polyunsaturated fatty acid. FAD2-1 is expressed only in the developing seed (Heppard et al. (1996) Plant Physiol. 110:311-319). The expression of this gene increases during the period of oil deposition, starting around 19 days after flowering, and its gene product is responsible for the synthesis of the polyunsaturated fatty acids found in soybean oil. GmFad 2-1 is described in detail by Okuley, J. et al. (1994) Plant Cell 6:147-158 and in WO94/11516. It is available from the ATCC in the form of plasmid pSF2-169K (ATCC accession number 69092). FAD 2-2 is expressed in the seed, leaf, root and stem of the soy plant at a constant level and is the “housekeeping” 12-desaturase gene. The Fad 2-2 gene product is responsible for the synthesis of polyunsaturated fatty acids for cell membranes.

Since FAD2-1 is the major enzyme of this type in soybean seeds, reduction in the expression of FAD2-1 results in increased accumulation of oleic acid (18:1) and a corresponding decrease in polyunsaturated fatty acid content.

Reduction of expression of FAD2-2 in combination with FAD2-1 leads to a greater accumulation of oleic acid and corresponding decrease in polyunsaturated fatty acid content.

FAD3 is a Δ-15 desaturase that introduces a third double bond into linoleic acid (18:2) to form linolenic acid (18:3). Reduction of expression of FAD3 in combination with reduction of FAD2-1 and FAD2-2 leads to a greater accumulation of oleic acid and corresponding decrease in polyunsaturated fatty acid content, especially linolenic acid.

Nucleic acid fragments encoding FAD2-1, FAD2-2, and FAD3 have been described in WO 94/11516 and WO 93/11245. Chimeric recombinant constructs comprising all or a part of these nucleic acid fragments or the reverse complements thereof operably linked to at least one suitable regulatory sequence can be constructed wherein expression of the chimeric gene results in an altered fatty acid phenotype. A chimeric recombinant construct can be introduced into soybean plants via transformation techniques well known to those skilled in the art.

Transgenic soybean plants resulting from a transformation with a recombinant DNA are assayed to select plants with altered fatty acid profiles. The recombinant construct may contain all or part of 1) the FAD2-1 gene or 2) the FAD2-2 gene or 3) the FAD3 gene or 4) combinations of all or portions of the FAD2-1, Fad2-2, or FAD3 genes.

Recombinant constructs comprising all or part of 1) the FAD2-1 gene with or without 2) all or part of the Fad2-2 gene with or without all or part of the FAD3 gene can be used in making a transgenic soybean plant having a high oleic phenotype. An altered fatty acid profile, specifically an increase in the proportion of oleic acid and a decrease in the proportion of the polyunsaturated fatty acids, indicates that one or more of the soybean seed FAD genes (FAD2-1, Fad2-2, FAD3) have been suppressed. Assays may be conducted on soybean somatic embryo cultures and seeds to determine suppression of FAD2-1, Fad2-2, or FAD3.

In one embodiment It is well understood by those skilled in the art that recombinant constructs comprising sequences other than those specifically exemplified which have similar functions, may be used. These constructs may include any seed-specific promoter. These constructs may or may not also include any nucleotides that promote stem-loop formation. These constructs may contain a polynucleotide having a nucleotide sequence identical to any portion of the gene or genes mentioned above inserted in sense or anti-sense orientation with respect to the promoter. Finally, these constructs may or may not contain any transcription termination signal.

In a first embodiment, the invention concerns an environmentally preferred frying oil, wherein said environmentally preferred frying oil has an increased oleic content when compared to an ordinary frying oil. The environmentally preferred frying oil is also useful as a blending source to make a blended environmentally preferred frying oil. The environmentally preferred frying oils of the invention are obtained from high olei oilseeds, such as, but not limited to, soybean, palm, peanut, canola, sunflower, corn, flax, cotton, and safflower.

A further embodiment of the invention the preferred frying oil of the invention comprises an oleic acid content of at least 60% of the fatty acid moieties in the oil. Another embodiment of the invention concerns a method for frying with a reduced impact on the environment, comprising: using an oil with an increased oleic acid content when compared to an ordinary oil and quantifying the reduction in environmental impacts when using a frying oil with an increased oleic acid content compared to an ordinary frying oil. The reduction of environmental impact can be at least one selected from the group consisting of: reduced carbon footprint, reduced eutrophication potential, reduced air acidification potential, and reduced non-renewable energy consumption.

Further embodiments of the invention include the use of a high oleic oil, wherein the use of the oil for frying applications reduces landuse pressure when compared to the use of an ordinary or oil for the same application.

The use of a high oleic oil, wherein the use of the oil for frying applications reduces the impact on the environment when compared to the use of an ordinary oil for the same application comprises also part of the invention.

Another embodiment of the invention concerns the use of the high oleic oil for frying applications, wherein the reduction of the impact on the environment is at least one selected from the group consisting of: reduced carbon footprint, reduced eutrophication potential, reduced air acidification potential, and reduced non-renewable energy consumption, when compared to the use of an ordinary oil for the same application.

The environmentally preferred or high oleic oils of the invention can be used as a blending source with an ordinary oil.

An additional embodiment of the invention concerns the use of an high oleic oil in a frying process, wherein the burden on the environment is reduced by at least 40% when compared to the use of a conventional oil.

The goal of this LCA was to compare high oleic oil with conventional oil used in a large-scale restaurant fryer application in the United States The environmental impacts studied in this LCA were greenhouse gas emissions, non-renewable energy use, eutrophication potential, and acidification potential. These were selected as critical environmental issues associated with agriculture related processes.

### Scope of the LCA

### Function and Functional Unit

It was assumed that the function of the oil is to fry food in a fast food restaurant. The functional unit used for this study was 2 days of frying. Each fryer has a 50 lb capacity and it was assumed that each restaurant has 4 fryers.

Losses to food were assumed to be 8 lbs per day. Top-off is required when oil is not replaced at the end of a day. For high oleic oil, 208 lbs of oil (8 lbs top-off for the fryers) are used for two days of frying in a fast food restaurant. For conventional oil, 400 lbs of oil are used for two days of frying in a fast food restaurant. Top off is not required for conventional oil since the oil is replaced each day. Washing of the fryer was included and assumed to be required every time the oil is changed.

### System Boundaries

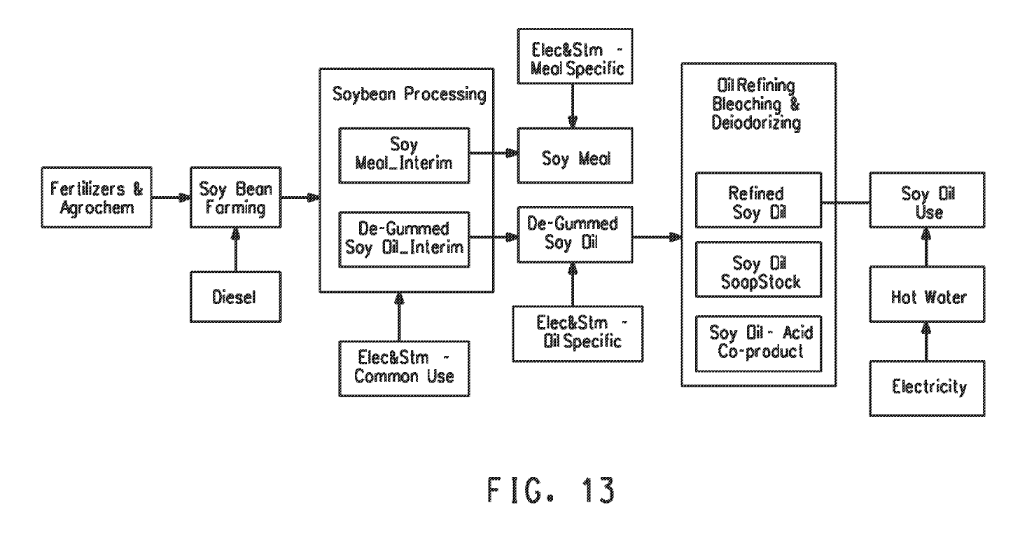

The system boundaries are shown in FIG. 13. The system included the following steps:
Agricultural chemical inputs
Soybean farming activities
Soybean processing into crude oil
Soybean oil refining, bleaching, and deodorizing
Soybean oil use in a large-scale restaurant fryer
Washing of the fryer
End of life of the oil, from the perspective of the restaurant
Transportation steps for all inputs and the beans and oil are included

### Key Assumptions

### Farming and Oil Production:

Soybeans and oil are produced in mid-west USA, Illinois
US average electricity is modeled for use at the soybean crushing mill
There is no difference in processing a high oleic soybean and a conventional soybean

### Use Phase:

The oils are used in a restaurant on the east coast of the USA, New York Metro
Soy oil is transported 900 miles to the restaurant by truck—NYC, base case
For the two days of frying, both types of oil can fry the same amount and type of food
There is no evidence of frying time differences between the oils, i.e. it is assumed food will not cook any faster in high oleic oil than it would in conventional oil
Absorption into the food results in 2 lb of oil loss to the food per 50 lb fryer

### Washing:

Washings coincide with oil changes, so the high oleic fryers would be cleaned ½ as many times as the conventional oil fryers
Washing procedure is based on Stratus Foods Fryer Tips
Two fryer volumes of water are used for washing including some vinegar
Water is heated to 200° F. with electric heat

### End-of-Life:

Yellow grease (the waste oil from the restaurant) is of no economic value or cost for the restaurant. Therefore, it is assumed that the yellow grease has no burdens and gets no credits, per the attributional approach from the perspective of the restaurant

### Exclusions:

Health impacts are not included since the focus of this study is environmental impacts
Any environmental effects due to infrastructure (example: additional storage at crushing mill for high oleic oil, burdens associated with manufacture of trucks used to transport the oil, etc.) are not included. These are assumed to be negligible in comparison to the process steps included.
Indirect effects such as indirect land use change are not included since this study uses an attributional modeling approach (i.e. focus on the specific supply chain for a frying oil used in a restaurant)
Per Pioneer expertise, soybean and oil loss during transport is negligible
Packaging is not included due to scope and time limitations. Including packaging would likely only improve the environmental profile of the high oleic oil further, since about half as much would need to be produced and therefore packaged, for the restaurant.
Electricity to run the fryer is not included. This input would be identical for the two oils for two days' worth of frying and would not differentiate the two types of oil.
No oil waste water treatment is included in the washing step. It is assumed that the small amount of oil which exits with the water to a municipal waste water treatment facility is negligible compared to the other flows treated.

### Allocation Procedures

There are steps in the oil supply chain which result in multiple products. In order to calculate the environmental impacts on an oil basis alone, allocation on some basis must be applied to account for co-products which result from the process. At the soybean processing step, both crude soybean oil and soybean meal are produced. Some subdivision of the system can be done. Certain inputs are only associated with the oil, and so these are applied to the oil only. However, many of the steps are associated with the meal and oil together. The three methods which were addressed in this study were economic allocation, mass allocation, and system expansion. Economic allocation divides the environmental burdens among co-products based on their relative economic value, while mass allocation distributes the environmental burdens based on the relative mass of each co-product. For the system expansion allocation approach, a credit is applied to the system for each co-product based on the environmental burden associated with manufacturing an equivalent amount of the marginal product, i.e. the product which would be replaced in the market-place by the co-product. Recent life cycle studies on conventional oil production for soybean oil and canola oil have used mass allocation and system expansion to account for the co-product meal, respectively. However, for this study, economic allocation is applied as the base case. Since manufacturing is assumed similar for high oleic and conventional oils, but high oleic oil is assumed to attract more value, only economic allocation accounts for the differences between high oleic and conventional oil. A sensitivity study was performed to evaluate all three allocation methods discussed. More details on allocation are included in the sensitivity analysis portion of this Example.

Additional allocation is required during the refining process for use in the food industry. At the refining, bleaching, deodorizing step, a distillate material and soapstock are also produced along with the refined oil. For this step in the base case, allocation based on economic value was applied. In the sensitivity, mass allocation was also investigated. For the case where system expansion is used for the meal and crude oil production step, the modeling was simplified by using economic allocation for the products out of the refining, bleaching, deodorizing step.

### Sources of the Data

Data for soybean farming and crude soybean oil production came primarily from a report prepared for the United Soybean Board by Omni Tech International titled “Life Cycle Impact of Soybean Production and Soy Industrial Products” [Omni, 2010]. All relevant soil emissions at the farm were not included in this report and were needed for this study. Therefore, other than dinitrogen dioxide emissions, all other soil emissions were calculated based on the fertilizer use rates and yields from the USB paper and equations provided by Thomas Nemecek and Thomas Kagi in the ecoinvent report no. 15, “Life cycle inventories of agricultural production systems” [Nemecek, 2007]. The USB report is based on U.S. average data from the years 2001-2007.

Data for the refining, bleaching, and deodorizing process came from a report by Jannick Schmidt titled “Life cycle assessment of rapeseed oil and palm oil, PhD Thesis Part 3: Life cycle inventory of rapeseed oil and palm oil” [Schmidt, 2007]. The relative amounts of co-products produced at this process step were based on internal Pioneer expertise of the technology.

Economic data was available from two separate sources. The Economics Research Service Oil Crops yearbook for the U.S. provides price and supply history for the U.S. soybean oil and soybean meal on a monthly basis from 2004 through the summer of 2009 at the time when data was collected for this study. The mundi index provides a monthly price history for meal and oil for a ten year timespan through the end of 2011 based on the Chicago Soybean Oil and Soybean Meal futures without associated supply volumes. Pricing agreed across both methods for the years where data was common. Using data that includes the most current pricing was deemed important for this analysis. As such we chose to use the data available through index Mundi. While supply of meal relative to oil also ranges from year to year, the same average data provided by the USB was used in order to remain consistent with other inputs and emissions associated with the USB data. Economic data for the refining co-products were not readily available. Prices for the refining co-products soapstock and distillate material were obtained from a Pioneer market expert.

### Case Descriptions

The entire supply chain from a restaurant's perspective for both high oleic oil and conventional oil was modeled. The supply chain included the farming of the crop, the pressing and extracting of the crop into crude oil and meal, refining the crude oil into food grade oil by neutralizing, bleaching and deodorizing, washing of the fryer, and end of life of the oil from the perspective of the restaurant. The model also included transportation for all inputs and the beans and oil. Conventional and high oleic soybean oils are assumed to be representative for other types of conventional and high oleic oils. It is assumed that there is no difference between processing a high oleic soybean and a conventional soybean. The soybean and oil are produced in mid-west USA, Illinois, and then transported via truck to a restaurant in New York City. Both base cases assume that environmental burdens are partitioned to co-products based on the co-product's economic value. Soy meal is produced during the pressing and extracting of the soybean into crude oil. A distillate material and soapstock are also sold as co-products, and are produced at the refining, bleaching and deodorizing of the refined oil. The base cases model two days at the restaurant, with washing procedures based on Stratus Foods Fryer Tips. Each time the fryer is emptied, it is cleaned and during cleaning the fryer is filled two times with water that is heated to 250 F and has some vinegar added to it. After the oil is used at the restaurant it is referred to as yellow grease, which has no economic value or cost for the restaurant. The yellow grease therefore receives no environmental benefit or burden in the LCA.

For the conventional oil base case, it is assumed that 400 lbs of oil for the two day fryer use was needed at the restaurant. There are four fryers at 50 lbs each that need to be emptied and refilled after one day of use. The fryer needed to be cleaned two times for that two day span.

For the high oleic oil base case, it is assumed that 208 lbs of oil for the two day fryer use was needed at the restaurant. After the first day, 2 lbs of oil are lost per fryer to food absorption, so 8 lbs of oil was needed as top-off for the four fryers on the second day. Since the high oleic oil lasts twice as long as conventional, the high oleic oil does not need to be emptied after the first day of frying. It is assumed that the fryer only needed to be cleaned one time, at the end of two days of frying.

In a first embodiment, the invention concerns an environmentally preferred frying oil, wherein said environmentally preferred frying oil has an increased oleic content when compared to an ordinary frying oil.

In a second embodiment, the invention concerns an environmentally preferred frying oil, wherein said environmentally preferred frying oil is useful as a blending source to make a blended environmentally preferred frying oil.

In a third embodiment, the invention concerns an environmentally preferred frying oil obtained from a high oleic oilseed. The oilseed is one selected from the group consisting of: soybean, palm, peanut, canola, sunflower, corn, flax, cotton, and safflower.

In a another embodiment, the invention concerns an environmentally preferred frying oil, wherein the oleic acid content of said oil comprises at least 60% of the fatty acid moieties in the oil.

In yet another embodiment, the invention concerns a method to determine that an oil is environmentally preferred for a frying process, comprising: using an oil with an increased oleic acid content when compared to an ordinary oil and quantifying the reduction in environmental impacts when using a frying oil with an increased oleic acid content compared to an ordinary frying oil.

A further embodiment of the invention concerns a method to determine that an oil is environmentally preferred for a frying process, comprising using an oil with an increased oleic acid content when compared to an ordinary oil and quantifying the reduction in environmental impacts when using a frying oil with an increased oleic acid content compared to an ordinary frying oil, wherein the reduction environmental impact is at least one selected from the group consisting of: reduced carbon footprint, reduced eutrophication potential, reduced air acidification potential, and reduced non-renewable energy consumption.

High oleic oil obtained from seeds, soybean, palm, peanut, canola, sunflower, corn, flax, cotton, and safflower are also part of the invention.

A further embodiment of the invention concerns the use of a high oleic oil, wherein the use of the oil for frying applications reduces landuse pressure.

An additional embodiment of the invention concerns use of a high oleic frying oil for reduction of environmental impact, such as a reduction of carbon footprint, reduction of eutrophication potential, reduction of air acidification potential, or reduction of non-renewable energy consumption.

### EXAMPLES

The present invention is further defined in the following Examples, in which parts and percentages are by weight and degrees are Celsius, unless otherwise stated. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various usages and conditions. Thus, various modifications of the invention in addition to those shown and described herein will be apparent to those skilled in the art from the foregoing description. Such modifications are also intended to fall within the scope of the appended claims.

### Example 1

### Transformation of Soybean (Glycine max)

### Embryo Cultures and Regeneration of Soybean Plants.

Soybean embryogenic suspension cultures are transformed by the method of particle gun bombardment using procedures known in the art (Klein et al. (1987) Nature (London) 327:70-73; U.S. Pat. No. 4,945,050; Hazel et al. (1998) Plant Cell. Rep. 17:765-772; Samoylov et al. (1998) In Vitro Cell Dev. Biol.-Plant 34:8-13). In particle gun bombardment procedures it is possible to use purified 1) entire plasmid DNA or, 2) DNA fragments containing only the recombinant DNA expression cassette(s) of interest.

Stock tissue for transformation experiments are obtained by initiation from soybean immature seeds. Secondary embryos are excised from explants after 6 to 8 weeks on culture initiation medium. The initiation medium is an agar-solidified modified MS (Murashige and Skoog (1962) Physiol. Plant. 15:473-497) medium supplemented with vitamins, 2,4-D and glucose. Secondary embryos are placed in flasks in liquid culture maintenance medium and maintained for 7-9 days on a gyratory shaker at 26+/−2° C. under ˜80 μEm-2s-1 light intensity. The culture maintenance medium is a modified MS medium supplemented with vitamins, 2,4-D, sucrose and asparagine. Prior to bombardment, clumps of tissue are removed from the flasks and moved to an empty 60×15 mm petri dish for bombardment. Tissue is dried by blotting on Whatman #2 filter paper. Approximately 100-200 mg of tissue corresponding to 10-20 clumps (1-5 mm in size each) are used per plate of bombarded tissue.

After bombardment, tissue from each bombarded plate is divided and placed into two flasks of liquid culture maintenance medium per plate of bombarded tissue. Seven days post bombardment, the liquid medium in each flask is replaced with fresh culture maintenance medium supplemented with 100 ng/ml selective agent (selection medium). For selection of transformed soybean cells the selective agent used can be a sulfonylurea (SU) compound with the chemical name, 2-chloro-N-((4-methoxy-6 methy-1,3,5-triazine-2-yl)aminocarbonyl)benzenesulfonamide (common names: DPX-W4189 and chlorsulfuron). Chlorsulfuron is the active ingredient in the DuPont sulfonylurea herbicide, GLEAN®. The selection medium containing SU is replaced every week for 6-8 weeks. After the 6-8 week selection period, islands of green, transformed tissue are observed growing from untransformed, necrotic embryogenic clusters. These putative transgenic events are isolated and kept in media with SU at 100 ng/ml for another 2-6 weeks with media changes every 1-2 weeks to generate new, clonally propagated, transformed embryogenic suspension cultures. Embryos spend a total of around 8-12 weeks in contact with SU. Suspension cultures are subcultured and maintained as clusters of immature embryos and also regenerated into whole plants by maturation and germination of individual somatic embryos.

### Example 2

### Fatty Acid Analysis of Soybeans

In order to determine altered fatty acid composition as a result of suppression of the fatty acid desaturase, the relative amounts of the fatty acids, palmitic, stearic, oleic, linoleic and linolenic, can be determined as follows. Fatty acid methyl esters are prepared from single, mature, somatic soybean embryos or soybean seed chips by transesterification. One embryo, or a chip from a seed, is placed in a vial containing 50 μL of trimethylsulfonium hydroxide and incubated for 30 minutes at room temperature while shaking. After 30 minutes 0.5 mL of hexane is added, the sample is mixed and allowed to settle for 15 to 30 minutes to allow the fatty acids to partition into the hexane phase. Fatty acid methyl esters (5 μL from hexane layer) are injected, separated, and quantified using a Hewlett-Packard 6890 Gas Chromatograph fitted with an Omegawax 320 fused silica capillary column (Supelco Inc., Cat#24152). The oven temperature is programmed to hold at 220° C. for 2.7 minutes, increase to 240° C. at 20° C. per minute, and then hold for an additional 2.3 minutes. Carrier gas is supplied with a Whatman hydrogen generator. Retention times were compared to those for methyl esters of commercially available standards (Nu-Chek Prep, Inc. catalog #U-99-A).

### Example 3

### Residual Fatty Acid Analysis by Acid Methanolysis

Triplicate samples (approximately 100 mg) were weighed, to a precision of 0.1 mg, into 13×100 mm screw capped (PTFE liners) tubes. After addition of C17:0 triacylglycerol internal standard (10 μl, 5% W:V stock in toluene), 1 ml of fresh methanolysis solution (5% sulfuric acid in anhydrous methanol) was added to each tube. The tubes were capped, vortex mixed and heated at 80° C. for 30 min, with vortex mixing every 10 minutes. The samples were cooled to room temperature and 1 ml of saline solution (25% sodium chloride in water), followed by 1 ml heptane, was added to each tube. After vortex mixing, the phases were separated by centrifugation (3000×g for 10 min) and the upper, organic phases, were transferred to GC sample vials. Fatty acid analysis was performed on an Agilent 6890 with FID detector. The GC was fitted with an OmegaWax-320, 30 m×0.32 mm×0.25 um column (Supelco, Bellefonte, Pa.). The carrier gas was hydrogen (28 cm/sec linear velocity) and the following temperature profile was used; 220° C. for 2.6 min, ramp at 10° C. to 240° C., hold for 1.4 min. Peak areas of the individual fatty acids were integrated, individual fatty acids were quantified relative to the C17 internal standard and fatty acid compositions were estimated based on these values. The assumption was made that the detector response for each fatty acid was the same (Morrison et al. (1980) Methods for the quantitative analysis of lipids in cereal grains and similar tissues. Journal of Science Food and Agriculture 31: 329-340).

Using the above-described technique, the fatty acid profile of residual fatty acids associated with hexane-extracted soy white flake flours and soy protein isolates manufactured from them was determined for commodity soybeans and two genetically altered soybean varieties, high oleic acid soybeans and low linolenic acid soybeans. The results are shown in Tables 9. Although it is recognized that other fatty acids are present in soybean oil and the residual lipid in soy products, they are only present at trace levels (<3% of total). For the sake of comparison in this patent we have restricted our analysis to the most abundant fatty acids i.e., palmitic (16:0), stearic (18:0), oleic (18:1), linoleic (18:2) and linolenic (18:3) acids.

The residual fatty acids associated with the hexane-defatted white flake flour and soy protein isolate is principally in the form of phospholipid, and therefore derived from membrane lipids, while the hexane-extracted soy oil is principally composed of storage triglycerides. Prior to this work it was not known how closely the residual fatty acid profile would be related to the fatty acid profile of hexane-extracted soy oil. From the data shown in Table 9 it can be seen that the level of palmitic acid increases in the residual fatty acids present in soy white flake flour and soy protein isolate compared to hexane-extracted soy oil in the three genetically different soybean varieties tested. In contrast, the level of oleic acid decreases in the residual fatty acids compared to hexane-extracted soy oil significantly in the commodity and low linolenic acid soybeans, but only marginally in the high oleic soybeans. The polyunsaturated fatty acids, linoleic and linolenic, are at similar levels in the residual fatty acids and hexane-extracted soy oil from the three genetically different soybean varieties.

The residual fatty acid content in soy white flake flour and soy protein isolate from low linolenic acid soybeans is lower in oxidatively unstable linolenic acid than that of commodity soy protein products, indicating that soy protein products produced from low linolenic acid soybeans are less likely to generate off-flavor compounds. Similarly, the residual fatty acid content in soy white flake flour and soy protein isolate from high oleic acid soybeans is lower in both of the polyunsaturated fatty acids, linoleic and linolenic, than that of commodity soy protein products, indicating that soy protein products produced from high oleic acid soybeans are less likely to generate off-flavor compounds.

TABLE 3
Fatty acid profiles of soy oils, of residual fatty acids in flours produced
from hexane-defatted soy white flake, and of soy protein isolates

| | 16:0 | 18:0 | 18:1 | 18:2 | 18:3 | % Total poly- |
|---|---|---|---|---|---|---|
| Sample ID | % | % | % | % | % | unsaturates |
| Commodity Soy | 8-13 | 2-6 | 18-27 | 51-59 | 6-10 | 57-69 |
| Oil¹ | | | | | | |
| High Oleic Soy Oil | 6-7 | 4-5 | 79-86 | 2-4 | 2-5 | 4-9 |
| Low Linolenic Soy | 10 | 5 | 29 | 53 | 3 | 62 |
| Oil⁴ | | | | | | |
| High Oleic/High | 12 | 22 | 60 | 3 | 3 | 6 |
| Saturate Soy Oil⁵ | | | | | | |
| High Oleic/High | 6 | 19 | 62 | 6 | 6 | 12 |
| Stearic Soy Oil | | | | | | |
| Commodity Soy | 17-27 | 5-7 | 11 | 49-58 | 7-9 | 56-67 |
| WFF² Residual | | | | | | |
| Fatty Acids | | | | | | |
| High Oleic Soy | 9-10 | 3-4 | 78-82 | 2-4 | 3-5 | 5-9 |
| WFF² Residual | | | | | | |
| Fatty Acids | | | | | | |
| Low Linolenic Soy | 24 | 7 | 10 | 57 | 3 | 60 |
| WFF² Residual | | | | | | |
| Fatty Acids | | | | | | |
| Commodity Soy | 18-24 | 5-7 | 14-15 | 45-55 | 5-7 | 50-62 |
| SPI³ Residual | | | | | | |
| Fatty Acids | | | | | | |
| High Oleic Soy | 8-10 | 3 | 80-83 | 2-3 | 3-4 | 5-7 |
| SPI³ Residual | | | | | | |
| Fatty Acids | | | | | | |
| Low Linolenic Soy | 26 | 6 | 15 | 52 | 2 | 54 |
| SPI³ Residual | | | | | | |
| Fatty Acids | | | | | | |

For this table fatty acid % relates the individual fatty acid to the sum of the five major fatty acids indicated. Other fatty acid types that are sometimes present and represent less than 3% of the total fatty acids are not considered for purposes of comparison.
¹Value ranges for the five major fatty acids in commodity soy oil are taken from “The Lipid Handbook” 2^{nd} ed., (1994) Gunstone, F. D., Harwood, J. L., Padley, F. B., Chapman & Hall.
²WFF = White flake flour from hexane-extracted soybeans
³SPI = Soy protein isolate produced from white flake flour
⁴Table X U.S. Pat. No. 5,710,369
⁵Table 9 U.S. Pat. No. 6,426,448
16:0 = palmitic acid, 18:0 = stearic acid, 18:1 = oleic acid, 18:2 = linoleic acid, 18:3 = linolenic acid
set of standards containing known concentrations of prepared methyl esters of selected fatty acids.

### Example 4

### Standard Frying Experiments

For the experiments Perfect Fry PFC Model Fryers are used. They are self contained with fire suppression and HEPA filter units.

They have a capacity of 2 gal (8 L; ˜171b) of oil, max product capacity 1 kg fries per cycle.
240V, 16A, 3750W (˜220 W/lb oil) element
Surface of Fryer vat 725 cm²

### General Protocol

### Fryers are set to 176 C (˜350 F).

Fryers charged with oil to cold fill line and sample (˜250 ml) is collected for analysis. Samples taken into brown glass bottle and are nitrogen capped and stored at 4 C until analysis. In most cases analysis is performed on the day of collection. Bring fryers up to temperature and measure polar compounds with quick test (Testo and FOM; instruments are inserted in oil to specified depth and moved slowly in a figure of 8 pattern prior to taking readings of temperature and total polar compounds) instruments.
Products: LambWeston ZTF 5/16″ string fries; straight from freezer (@−20 C)
Lamb Weston ⅛″ Natural potato chips; straight from freezer (@−20 C)
   Day 1: 5×200 g French Fries . . . 2 min 50 second drops every 45 min throughout morning shift.
5×250 g potato chips;
   Batch 1 cooked for 3 min
   Batch 2 cooked for 4 min
   Batch 3 cooked for 5 min
   Batch 4 cooked for 6 min
   Batch 5 cooked for 7 min
      This series is performed throughout the afternoon shift with drops every 45 min and is used to access product color with Konica color meter; readings are taken on whole product and after crushing to achieve a more homogeneous sample.
      Turn fryers off after 8 h and allow to cool overnight. In “standard” experiments oils are not filtered and oil level is not topped off to replace oil lost during the days frying.

### Subsequent Days:

5×200 g French Fries . . . 2 min 50 second drops every 45 min throughout morning shift.
5×250 g potato chips . . . 5 min drops every 45 min throughout afternoon shift.
On the day that the oil is going to exceed polar compound specifications (25% TPC on Testo Instrument) the day 1 protocol is repeated to collect product color data.

### Analysis.

### Total Polar Compounds:

### Testo 270 Oil Tester; Testo Inc, Sparta N.J.

Ebro 310 FOM Oil Tester; Ebro http://www.ebro.com/en/products

### Color:

(Lovibond PFX950) at room temperature.
AOCS 5¼″ cuvette for starting oil
Gardener (10 mm cuvettes) starting oil and for fryer samples from subsequent days

### Product Color: Konika Minolta CR-410 Colorimeter.

### Free Fatty Acids; Titration Mettler Method M345

Peroxide Values; Iodometric titration. Mettler Method M3406
p-Anisidine; AOCS Cd 18-90

### Other Measurements:

Fatty Acid Comps (area %; wt %) AOCS Ce 2-66 (prep BF₃ equiv+sodium methoxide); Ce 1e-91

### Tocopherols; AOCS Ce 8-89

Oxidative Stability Index (OSI); AOCS Cd 12b-92
Product oil content (gravimetric)

### Example 5

### Frying Experiment Using Soy and Canola Oils with Various Oleic Acid Levels

The internal laboratory experiments were conducted as describes in Example 10 and the results are shown on Table 4.

TABLE 4
Internal lab testing

| | | | % TPC¹ at |
|---|---|---|---|
| Fryer | | C18:1 | experiment |
| Experiment | Oil Type | content | termination |
| 8 | Plenish ™ ²-no | 77.7 | 23.9 (Day 11) |
| | additives³ | | |
| 8 | Commodity Soy | 22.2 | 25.0 (Day 4) |
| 9 | Plenish ™ -no additives | 78.7 | 25.7 (Day 8) |
| 9 | Mid oleic Canola-no | 68.9 | 24.7 (Day 8) |
| | additives | | |
| 10 | Plenish ™ -no additives | 78.7 | 24.6 (Day 6) |
| 10 | Mid oleic Canola-no | 65.3 | 26.9 (Day 6) |
| | additives | | |
| 11 | Plenish ™ -with | 70.3 | 6.7 (Day 5) |
| | additives | | |
| 11 | Commodity -with | 20.2 | 14.9 (Day 5) |
| | additives | | |
| 12 | Plenish ™ -no additives | 78.8 | 25.0 (Day 12) |
| 12 | Commodity soy | 23.0 | 28.5 (Day 5) |
| 14 | Mid oleic canola with | 63.9 | 23.0 (Day 14) |
| | additives | | |
| 14 | Plenish ™ -with | 71.6 | 23.0 (Day 14) |
| | additives | | |
| 16 | High oleic Canola -no | 78.7 | 25.0 (Day 10) |
| | additives | | |
| 16 | Plenish ™ -no additives | 78.8 | 25.0 (Day 10) |

¹% TPC refers to the percentage of Total Polar Compounds. This measurement is used to estimate the degradation of the oil during frying. Once the % TPC reaches 25% the oil is considered spent.
² Plenish ™ is a high oleic soybean oil.
³The anti-foaming agent silicon and TBQH are usually added to oil that are used for frying on a commercial scale. Data with and without addition of these additives are shown.

### Example 6

### External Commercial Testing Testing Plenish™ Under Commercial Conditions

In a typical experiment under commercial conditions Frymaster 50 lb oil capacity electrically heated or Vulcan, 70 lb oil capacity, natural gas heated, fryers were used. The food type and quantity of food produced during the tests was determined by the daily demand at the restaurant and included chicken, with and without batter, French fries, onion rings and fresh potato chips. Oil testing was performed throughout a typical oil use cycle.

In one comparator experiment a pair of side by side Frymaster fryers was used. After the standard weekly oil change and cleaning one fryer was charged with 50 lb of Plenish™ frying oil and the other with a standard commodity soy based frying oil (Sysco Reliance (Sysco #4518403) with an oleic acid content of ˜24%. Both oils were fortified with typical antioxidant packages (TBHQ (tertiary Butylhydroxyquinone) and PDMS antifoam (poly dimethylsiloxane)). Oil samples from each fryer were taken immediately after the fryers were charged with the fresh oil but before the fryers were turned on. The oil samples were placed into 250 ml brown Nalgene® food grade bottles which were kept refrigerated until they were returned to the lab for testing. On subsequent days the fryers were turned off at the end of the shift (the fryers were on for approximately 8 hours per day) and allowed to begin to cool. Oil temperature and Total Polar Compounds measurements were performed in the fryers using a Testo 270 Oil Tester (Testo Inc, Sparta N.J.) calibrated according to the manufacturer's instructions. An oil sample from each fryer was then ladled into a shallow stainless steel tray, nestled in a bed of ice, and allowed to cool to approximately room temperature before transferring to the sample bottles. Oil samples were transported to the lab on a daily basis and were either analyzed directly or capped with nitrogen gas and stored at 4° C. until testing was completed. The tests performed on the oil were as described for the lab based experiments and included Total Polar Compounds (TPC), oil color, primary and secondary oil oxidation, free fatty acids, fatty acid profiles and tocopherol contents. Product color and fat content were measured in some experiments.

After 5 days the TPC of the commodity soy based frying oil was 18.3% and that of the Plenish™ frying oil was 12.9%. Using a value of 25% TPC as an indicator of spent oil that must be changed, the experiment was terminated. Subsequent experiments used Plenish™ frying oil in both fryers and introduced regular skimming of debris during the workday and a whole oil filtration and fryer clean after the 5^{th} day of regular use. Measurements of TPC showed that the Plenish™ frying oils remained below 25% polars, with no noticeable reduction in product quality, after 10 full days of use.

TABLE 5

| | | | % TPC¹ at |
|---|---|---|---|
| Fryer | | C18:1 | experiment |
| Experiment | Oil Type | content | termination |
| 4 | Plenish ™ ²-with additives³ | 71.6 | 10.8 (Day 10) |
| 4 | Plenish ™ ²-with additives³ | 71.5 | 11.5 (Day 10) |
| 1 | Stratas FryMax supreme | 75.3 | 8.0 (Day 5) |
| | Plenish ™ ² | | |
| 1 | Stratas FryMax supreme | 75.3 | 7.5 (Day 5) |
| | Plenish ™ ² | | |
| 2 | Stratas FryMax supreme | 75.5 | 8.0 (Day 6) |
| | Plenish ™ ² | | |
| 2 | Stratas FryMax supreme | 75.5 | 6.0 (Day 6) |
| | Plenish ™ ² | | |

From the results in Table 5 it can be seen that High oleic soybean oil (Plenish™) has more than twice as much frying life compared to commodity soybean oil and performs similar to mid and high oleic canola oil.

### Example 7

### LCA Study

For each impact assessment, the burdens associated with different steps of the supply chain were segregated to identify their contribution to the total burden. The term “Farming” includes the production, transportation, application of the fertilizers, soil emissions, and the energy used for the tractors and driers at the farm. The term “Crude Oil” includes the transportation of the soybean from the farm to the crude oil production facility, and all energy and materials associated with the pressing and extracting of the soybean into the crude oil and meal. The term “Refined Oil” pertains to the neutralization, bleaching and deodorizing process steps to make food grade soybean oil. The “Transport” step of the supply chain includes the one-way transportation of the refined oil from the plant in Illinois to a New York City restaurant. The term “Washing” includes the cleaning of the fryer after each time the fryer is emptied.

For each impact category, a comparison of the relative magnitude of the impacts for each of the base cases is provided. Both base case results assumed two day fryer use in New York City.

### Example 8

### Climate Change Potential

According to the US Environmental Protection Agency, “Climate change refers to any significant change in the climate lasting for an extended period. Climate change can be caused by natural factors, natural processes, and human activities. Climate change potential is measured in terms of total greenhouse gas emissions, and takes into account the global warming potential of specific species known to contribute to climate change.

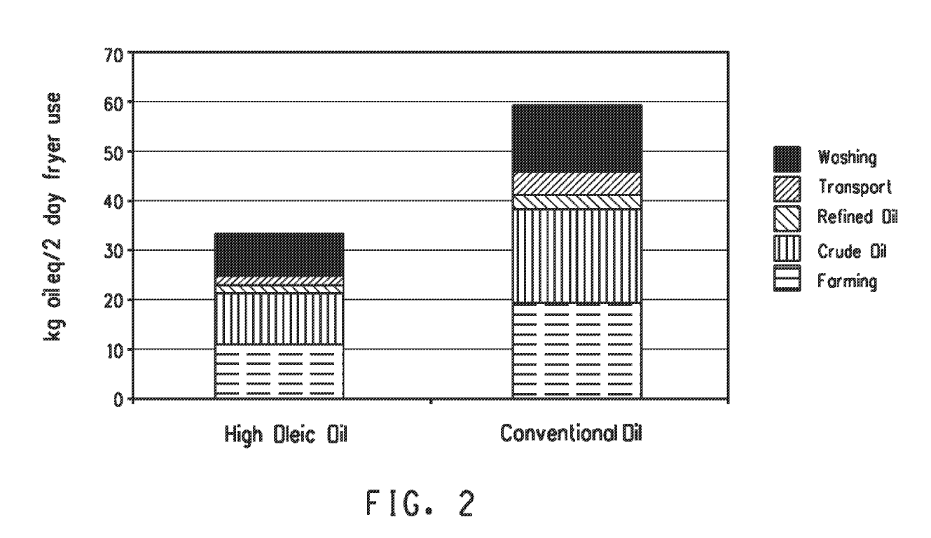

The climate change potential for both conventional oil and high oleic oil base cases can be seen below in FIG. 2. The climate change potential for the conventional oil is 220 kg CO₂ eq per 2 day fryer use, and for high oleic oil the climate change potential is 120 kg CO₂ eq per 2 day fryer use. The base case for high oleic oil is 45% lower than the base case for conventional oil in terms of climate change potential. “Farming” contributed roughly 50% and was the largest contributor to both oils. The “Crude Oil” piece of the supply chain is the second largest contributor at roughly 23% of the climate change potential. “Washing” of the fryer is also a significant contributor, which contributed 16% to conventional oil and 14% to high oleic oil. “Refined Oil” and “Transport” are both under 10% of the total climate change potential for a restaurant.

### Example 9

### Non-Renewable Energy Use

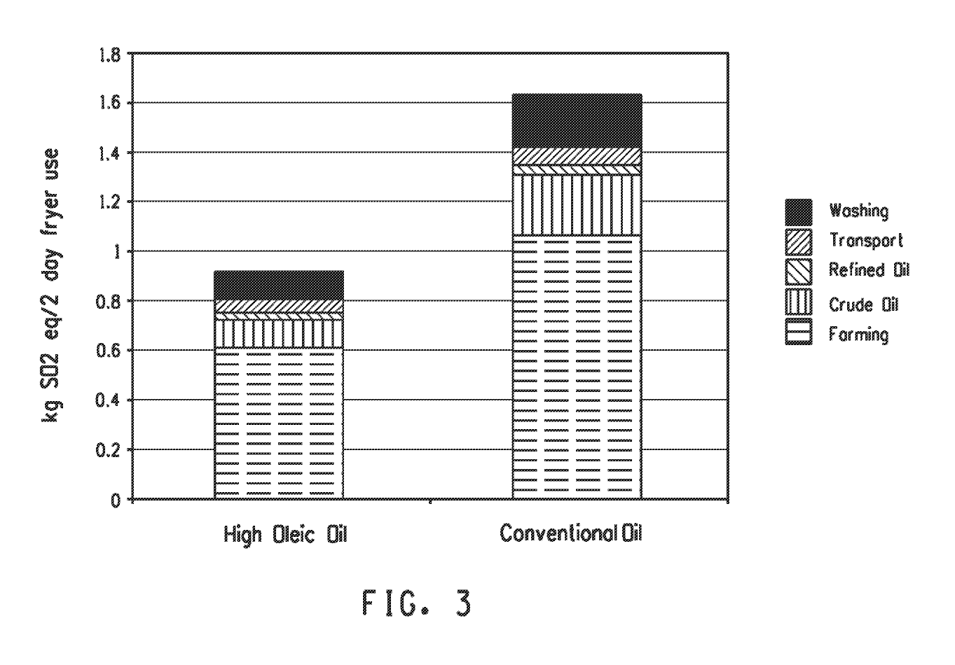

Non-renewable energy use accounts for all of the coal, oil, natural gas, and uranium consumed in the supply chain. Conventional oil and high oleic oil base case non-renewable energy use from a restaurant's perspective for two day fryer use can be seen in FIG. 3. The high oleic oil base case was 45% lower in non-renewable energy use than the conventional oil base case, with high oleic oil using 32 kg oil eq per 2 day fryer use and conventional oil using 59 kg oil eq per 2 day fryer use. “Farming” was the largest contributor for non-renewable energy, which contributed 35% for high oleic oil and 33% for conventional oil. The “Crude Oil” step contributed 31% of the total non-renewable energy use for high oleic oil and 33% for conventional oil. The “Washing” step contributed 21% of the total non-renewable energy use for high oleic oil and 23% for conventional oil. For both oils the “Refined Oil” and “Transport” steps contributed less than 10% of the total non-renewable energy use.

### Example 10

### Terrestrial Acidification Potential

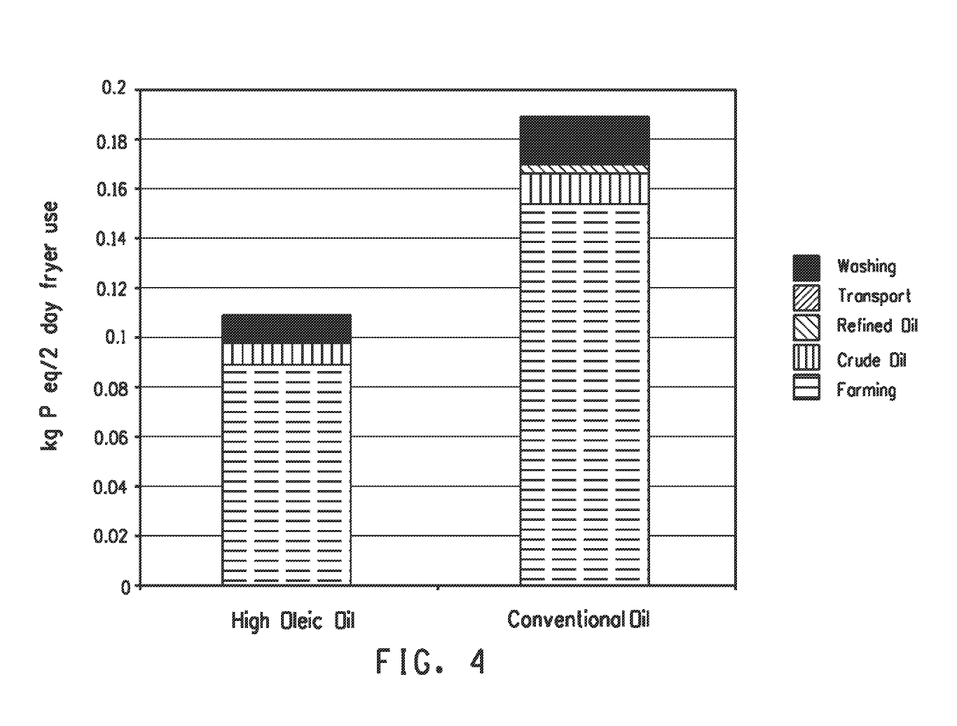

Terrestrial acidification potential is caused by emissions which alter optimum soil pH. The emissions that contribute to acidification are NOx, ammonia, and SO₂. Terrestrial acidification potential for both base cases can be seen in FIG. 4. The terrestrial acidification potential for the conventional oil is 1.6 kg SO₂ eq per 2 day fryer use, and for high oleic oil the terrestrial acidification potential is 0.91 kg SO₂ eq per 2 day fryer use. The base case for high oleic oil is 44% lower than the base case for conventional oil. “Farming” was the largest contributor at 65% for conventional oil and 67% for high oleic oil. The “Crude Oil” step in the supply chain is the second largest contributor at roughly 14% of the terrestrial acidification potential. “Washing” of the fryer is also a significant contributor, which contributed 13% to conventional oil and 11% to high oleic oil. “Refined Oil” and “Transport” are both under 5% of the total terrestrial acidification potential for a restaurant.

### Example 11

### Freshwater Eutrophication Potential

Freshwater eutrophication occurs when a fresh waterbody is overloaded with nutrients. This overload causes an increase in algal growth and a subsequent reduction in oxygen availability for aquatic life. Freshwater eutrophication is caused by phosphorous-containing emissions.

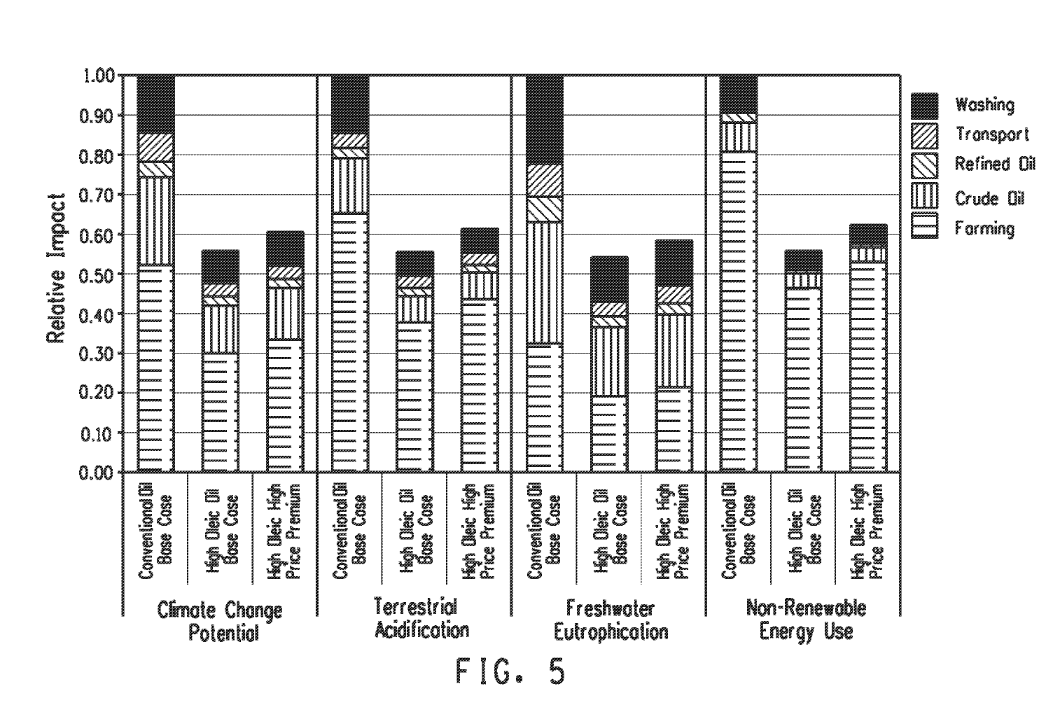

Freshwater eutrophication potential for conventional oil and high oleic oil use in a restaurant can be seen below in FIG. 5. The high oleic oil base case was 43% lower in freshwater eutrophication potential than the conventional oil base case, with high oleic oil resulting in 0.11 kg P eq per 2 day fryer use and conventional oil resulting in 0.19 kg P eq per 2 day fryer use. “Farming” was by far the largest contributor for freshwater eutrophication potential, which contributed 82% for high oleic oil and 83% for conventional oil. The “Washing” phase contributed 8% of the total freshwater eutrophication potential for high oleic oil and 9% for conventional oil. The “Crude Oil” step contributed 7% of the total freshwater eutrophication potential for both high oleic oil and conventional oil. For both oils the “Refined Oil” and “Transport” pieces of the supply chain contributed less than 2% of the total freshwater eutrophication potential.

### Example 12

### Sensitivity Analysis

### Economic Allocation Factors—Temporal Influences

As noted above, economic allocation was used as the base case for this study for oil with respect to meal co-product as well as co-products in the refining process. As market values vary over time, the relative value of these co-products with respect to the oil also fluctuates. The base case used the average price for both conventional crude soybean oil and soybean meal over the 10-year period from 2001-2011 as provided by the Chicago Soybean Oil and Soybean Meal Futures and the average production volumes of oil and meal as used in the USB LCA report [Omni, 2010]. An allocation factor of 39% was determined for conventional soybean oil relative to soybean meal for the base case as shown in Table 1. As high oleic soybean oil is not yet in the market space, an assumed price adder of 6 cents per pound was used for both high oleic crude soybean oil and high oleic refined soybean oil with respect to conventional oil. Further sensitivity analysis was done with regard to this price adder. Meal prices were not adjusted. An allocation factor of 41% was determined for high oleic soybean oil relative to soybean meal for the base case as shown in Table 2. A sensitivity was performed to address the maximum and minimum relative allocation factors derived by using pricing data from the past 10 years and the average relative yield of soybean meal with respect to soybean oil.

TABLE 6
Economic and mass allocation factors for
conventional crude soybean oil and meal

| Conven- | | | Relative | | | |
|---|---|---|---|---|---|---|
| tional | | | Produc- | | Economic | Mass |
| Crude | | | tion | | Allo- | Allo- |
| Soybean | Temporal | | USB | Price | cation | cation |
| Oil & Meal | Basis | Product | basis | $/kg | Factor | Factor |
| Base Case | Ave 2001- | Oil | 1000 | $0.74 | 39% | 19% |
| | 2011 | Meal | 4131 | $0.28 | 61% | 81% |
| Minimum | 9-Jun | Oil | 1000 | $0.83 | 31% | 19% |
| | | Meal | 4131 | $0.44 | 69% | 81% |
| Maximum | 8-May | Oil | 1000 | $0.60 | 47% | 19% |
| | | Meal | 4131 | $0.17 | 53% | 81% |

TABLE 7
Economic and mass allocation factors for
high oleic crude soybean oil and meal

| | | | Relative | | | |
|---|---|---|---|---|---|---|
| High Oleic | | | Produc- | | Economic | Mass |
| Crude | | | tion | | Allo- | Allo- |
| Soybean Oil | Temporal | | USB | Price | cation | cation |
| & Meal | Basis | Product | basis | $/kg | Factor | Factor |
| Base Case | Ave 2001- | Oil | 1000 | $0.80 | 41% | 19% |
| | 2011 | Meal | 4131 | $0.28 | 59% | 81% |
| Minimum | 9-Jun | Oil | 1000 | $0.89 | 33% | 19% |
| | | Meal | 4131 | $0.44 | 67% | 81% |
| Maximum | 8-May | Oil | 1000 | $0.66 | 49% | 19% |
| | | Meal | 4131 | $0.17 | 51% | 81% |

The conventional oil economic allocation factor with respect to meal varied from 31% to 47% over the past ten years with an average of 39%. Assuming a 6 cent per pound ($0.132/kg) price adder for high oleic offerings, the high oleic allocation factor with respect to meal varied from 33% to 49% with an average of 41%.

Additionally, allocation is performed for the products from the oil refining process where distillate and soapstock are co-produced along with refined oil. Table 3 shows the allocation factors for both conventional and high oleic oil. Since the value of the distillate co-product is significantly higher than refined oil, the economic allocation factors for the oil are lower than the mass allocation factors. Since these were spot prices as opposed to average data across the past ten years, and the factors for soapstock and distillate were small, sensitivity of the economic allocation factors for refined oil was not further evaluated. These factors were used for refined oil for the base case and the cases evaluating the minimum and maximum oil economic allocation factors with respect to meal.

TABLE 8
Economic and mass allocation factors for the co-products at the oil
refining process step for both conventional and high oleic oil

| | | |
|---|---|---|
| | | Mass Allocation |
| | Economic Allocation | Factor |
| | Factors - Base Case | Conv. & High |
| Product | Conventional | Oleic |

| | | | |
|---|---|---|---|
| Oil | 96.3% | 96.8% | 98.7% |
| Soapstock | 0.1% | 0.1% | 0.7% |
| Distillate | 3.6% | 3.1% | 0.6% |

On a functional unit basis, variation in the economic allocation factors based on temporal price fluctuations did not result in significant differences in the relative burdens of the high oleic case as compared to the conventional oil case. The high oleic case resulted in potential burdens in all categories studied which were consistently 43%-47% lower than the conventional oil. This corresponds closely with the 48% reduction in oil provided by the longer use life of the high oleic oil.

### Example 13

### High Oleic Price Premium—Impact on Economic Allocation Factors

Since high oleic soybean oil is not yet in the market, the price of high oleic oil relative to conventional oil can only be estimated. As high oleic offerings saturate the market, price premiums would be expected to be about six cents per pound ($0.132/kg). This price premium was used for high oleic oil in the base case for this study. However, initial price premiums would be higher. As such, a sensitivity analysis for the high oleic price premium at 15 cents per pound ($0.331/kg) was investigated.

The resulting economic allocation factor for high oleic soybean oil at a price adder of 15 cents per pound is 48% with respect to soybean meal. The resulting economic allocation factor for refined soybean oil with respect to soapstock and distillate is 97.4%.

Alternatively, the price adder could be less than the assumed 6 cents per pound. However, this would only further favor high oleic oil since the allocation factors for the oil would be lower than they are for the base case. To be conservative, this case was excluded from the study.

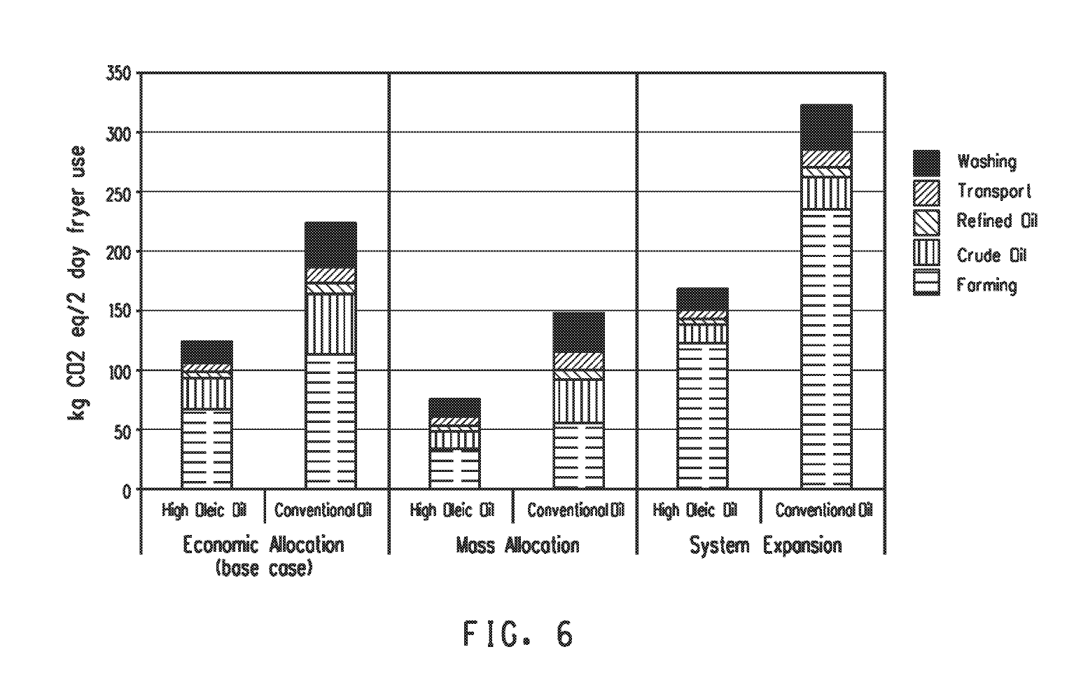

Results for the four impacts of interest in this study are presented in FIG. 6. A change in allocation factor results in a 7%-11% increase in burdens for the high oleic oil as compared to the base case high oleic oil depending on the impact category. For impact categories where farming is more important, like freshwater eutrophication, the higher allocation factor for oil with respect to meal has a larger overall influence. However, the high oleic case with a high premium still presents greater than 37% lower impacts when compared to conventional oil in all impacts evaluated.

### Example 14

### Alternative Allocation Methods

Additional allocation methods can be used to account for the co-product meal and refining co-products. Mass allocation is used by the United Soybean board in its LCA on conventional soybean oil in the United States. This method distributes the environmental burdens based on the relative mass of products in each process. Tables 1 and 2 show that the soybean oil mass allocation factor with respect to soybean meal is 19% for both conventional and high oleic oil. This alternative allocation factor reduces the overall burdens for the cases studied based on the functional unit, but does not significantly change the relative performance of high oleic oil with respect to conventional soybean oil.

System expansion is a much more complicated means of allocating the co-products of the process. For this sensitivity analysis, this study followed the method used in the Canola Council for North America LCA on conventional canola oil where soybean meal is identified as the marginal meal (protein source) for this market and canola oil is the marginal oil [(S&T)2], 2010]. The Canola Council simplified the analysis by ignoring differences in energy content between soybean meal and canola meal, but these omissions do not significantly affect the conclusions of this study. Following the method detailed in the Canola Council report, environmental impacts were higher for both oils than those reported for either mass allocation or economic allocation. However, this allocation method maintains similar relative impacts of high oleic oil as compared to conventional oil.

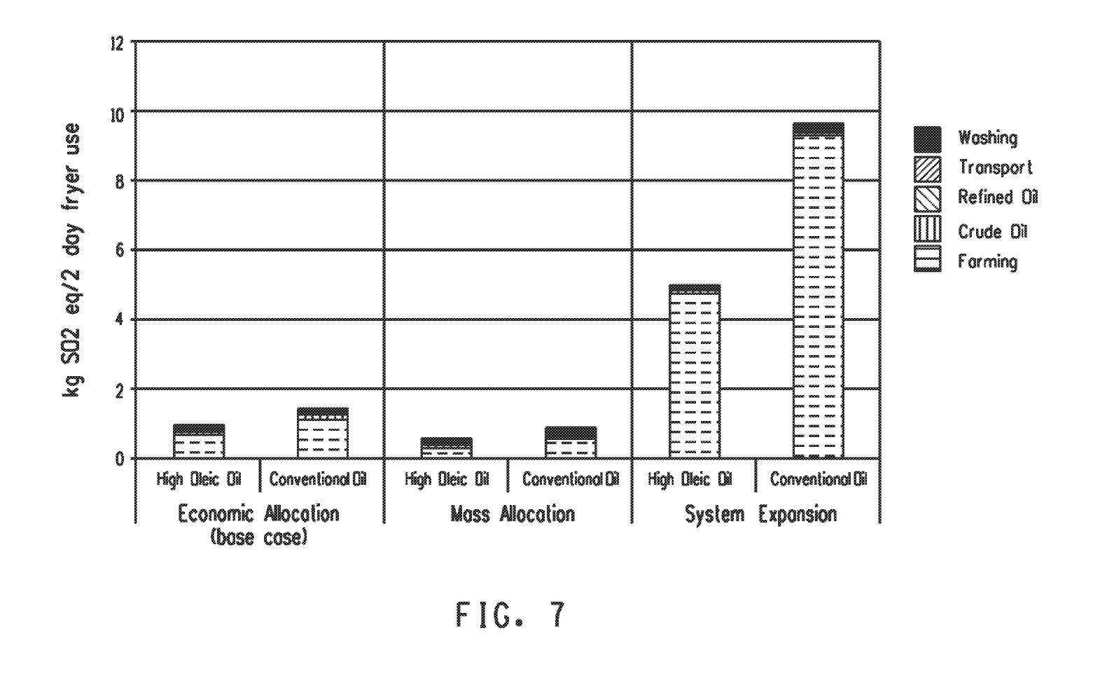

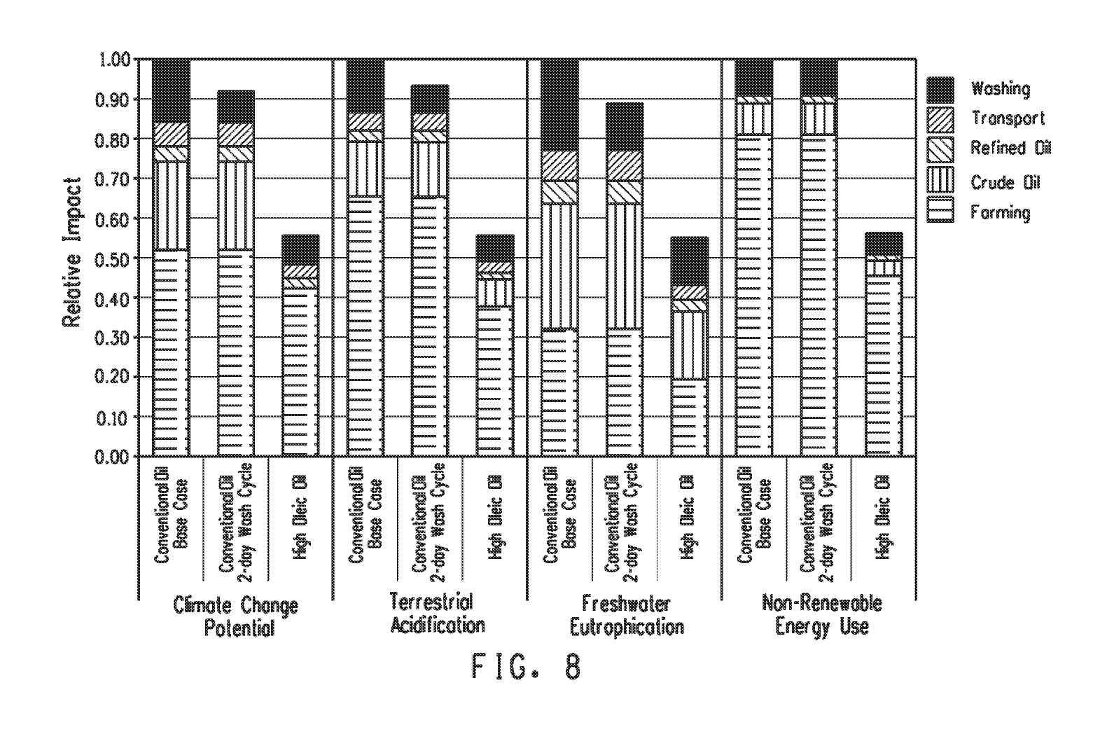

FIG. 7 shows climate change potential for both cases using all three allocation methods. Mass allocation showed the lowest overall burdens due to the significant mass of co-product meal produced from the soybean. System expansion showed the highest overall burdens due to the assumptions of marginal products in the market. FIG. 8 highlights similar results for terrestrial acidification. For this metric, farming impacts were more important which resulted in larger relative differences among allocation methods. However for each allocation method and all impact categories studied, high oleic oil presented 43%-48% lower impact potential than conventional oil. This is mainly attributable to the reduced oil use rate for the high oleic oil case.

### Example 15

### Washing Frequency

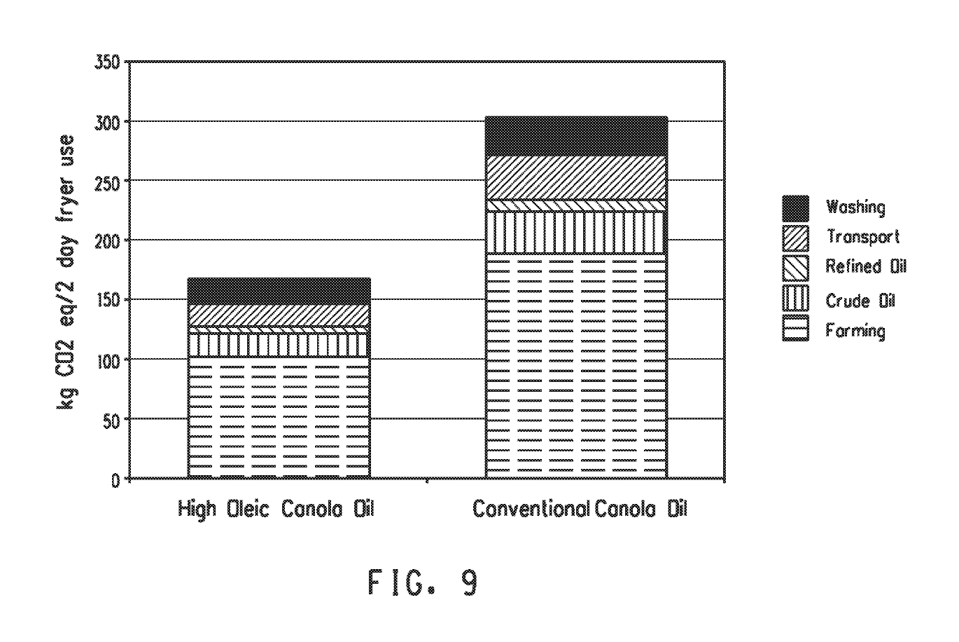

The base case assumed washing of the fryers occurs every time the oil was changed. This results in two washing cycles for the conventional oil for every one washing cycle for high oleic oil as defined in the functional unit. If a restaurant chooses to wash the fryers every other day, even for conventional oil, then the reduced change out frequency for high oleic oil would have no influence on washing impacts. In other words, both oil types would require one wash cycle every two days. FIG. 9 shows the impact of changing the washing basis for every changeout to every other day. The three cases shown in the figure are the Conventional Oil-Base Case, the Conventional Oil-2-day wash cycle case, and the High Oleic Oil case. For each impact category, results are normalized with respect to the Conventional Oil-Base Case impacts. The washing burdens for high oleic oil as defined by the assumptions in this study are the same as those for the conventional Oil 2-day wash cycle case.

As shown in the results for the base case, the importance of washing varies by impact category. Depending on the impact category, the reduction in washing results in a 5%-11% reduction in overall burdens for the Conventional oil 2-day wash Cycle Case with respect to the base case for conventional oil. The high oleic oil case provides a 43%-45% reduction in burdens for the impact categories studied as compared to the conventional base case. These high oleic oil benefits are marginally reduced to 38%-40% compared to the conventional oil 2-day wash cycle case. Although washing intensity may also be reduced for high oleic oil compared to conventional oil due to the reduction in polymerization during use, this study assumed washing intensity was similar for both oil types. Only the frequency of washing was varied.

### Example 16

### Transportation from Oil Producer to Local Warehouse

Since this case assumed conventional oil and high oleic oil can be produced in the same or similar location, transportation needs will vary directly with the amount of oil needed in each case. Changing the restaurant location from New York to Chicago to Los Angeles would have a minor impact on the magnitude of the environmental impacts studied for each case, but the relative impacts of high oleic to conventional oil remain essentially unchanged.

### Example 17

### Interpretation/Conclusions

The chemistry of high oleic oils has been shown to provide benefits in use as compared to conventional oils by reducing product degradation. For this study, industry experience has identified fry oil use rates may be extended at least twice as long as those for conventional oil. The lower use rate translates into improved environmental performance for each of four impact categories studied. This conclusion is based on the analysis of a functionally equivalent system where the entire supply chain for the oil is evaluated using life cycle methodology to address raw material extraction, intermediate and final product manufacture, oil use, and end of life impacts. This study provides these results through the perspective of a restaurant, i.e. the user and point of power in the market with respect to oil selection. In accordance with the ISO standard 14040 (page 16, section 5.5), “the interpretation reflects the fact that the LCIA results are based on a relative approach, that they indicate potential environmental effects, and that they do not predict actual impacts on category endpoints, the exceeding of thresholds or safety margins or risks” [ISO, 2006].

Processing associated with farming of soybeans is consistently the highest contributor to burdens for both types of oil across all impact categories. For terrestrial acidification and freshwater eutrophication, farming represents 65% and 80% of the total burdens. While the refining process is relatively insignificant, the crude oil production process does contribute significantly to the overall burdens for the impacts measured. While not the controlling factor, washing impacts as defined in the base case are both significant and differentiating with respect to high oleic and conventional oil.

Further analysis were performed to address the sensitivity of the results with respect to economic allocation factors which may change due to price variability of oil and its co-products over time or due to price premiums received for high oleic oils. Additional sensitivity analyses were performed to address alternate allocation methods for co-products in the oil supply chain and assumptions around fryer washing frequency. Although the magnitude of the impacts may change significantly, especially for changes in allocation factors and allocation methods, the relative impacts of high oleic oil and conventional oil remain consistent and similar in proportion to oil use rate. When washing frequency is assumed to be on a 2-day cycle instead of coinciding with each oil changeout, high oleic benefits are reduced marginally by only 10% across all impacts studied. When using economic allocation, high price premiums for high oleic oil with respect to conventional oil also result in reduced high oleic oil benefits for the impacts studied. However, even at a 15¢/lb oil premium, high oleic oil still provides nominally 40% reductions in burdens relative to conventional oil for the impacts studied.

Although this study was based on soybean oil, similar results would be expected for other similar products such as canola (or rapeseed) oil, sunflower oil, or palm oil. The overall magnitude of the benefits may change, but so long as the fry-life of the oil is extended, leading to reduced oil use rates, high oleic oil would be expected to provide lower environmental burdens for the impact categories studied. This is shown in Example 18 below, where conventional canola oil is compared to high oleic canola oil.

This study confirms that, from the perspective of a restaurant owner, the performance benefits of increased fry life for high oleic oils with respect to conventional oils translates to reduced environmental burdens for the impact categories of climate change potential, terrestrial acidification, freshwater eutrophication, and non-renewable energy use.

### Example 18

### Comparison of Canola to Soybean Oil

As stated previously, while this study was based on soybean oil, similar results would be expected for other oil products such as canola (or rapeseed) oil, sunflower oil, or palm oil. As an example, results for the same four environmental impacts were calculated for high oleic canola oil compared to conventional canola oil.

The LCA report prepared for the Canola Council for North America on conventional canola oil was used as the primary data source for canola farming [(S&T)2, Consultants Inc., “Lifecycle Analysis Canola Biodiesel”, prepared for Canola Council of Canada, November, 2010]. As with soy bean farming, except for dinitrogen monoxide which was calculated per the (S&T)2 report, these data were supplemented with soil emissions information provided by Thomas Nemecek and Thomas Kagi in the ecoinvent report no. 15, “Life cycle inventories of agricultural production systems” [Nemecek and Kagi, Ecoinvent report no. 15, data v2.0, “Life cycle inventories of agricultural production systems”, 2007]. Data for crude canola oil production at the mill and for the refining, bleaching, and deodorizing process came from a report by Jannick Schmidt titled “Life cycle assessment of rapeseed oil and palm oil, PhD Thesis Part 3: Life cycle inventory of rapeseed oil and palm oil” [Schmidt, Jannick H., “Life cycle assessment of rapeseed oil and palm oil, PhD Thesis Part 3: Life cycle inventory of rapeseed oil and palm oil”, Department of Development and Planning, Aalborg University, 2007].

The climate change potential for both conventional canola oil and high oleic canola oil base cases can be seen in FIG. 9. Results are similar compared to soy oil, with high oleic canola oil about 45% lower in climate change potential than conventional canola oil.

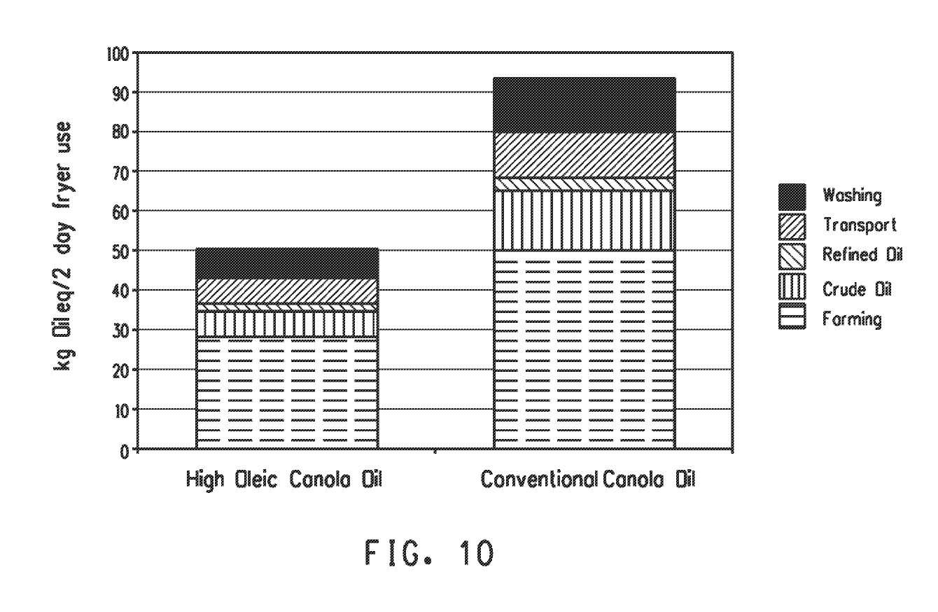

Conventional canola oil and high oleic canola oil base case non-renewable energy use from a restaurant's perspective for two day fryer use can be seen in FIG. 10. As with soy oil, the high oleic canola oil base case was about 45% lower in non-renewable energy use than the conventional canola oil base case.

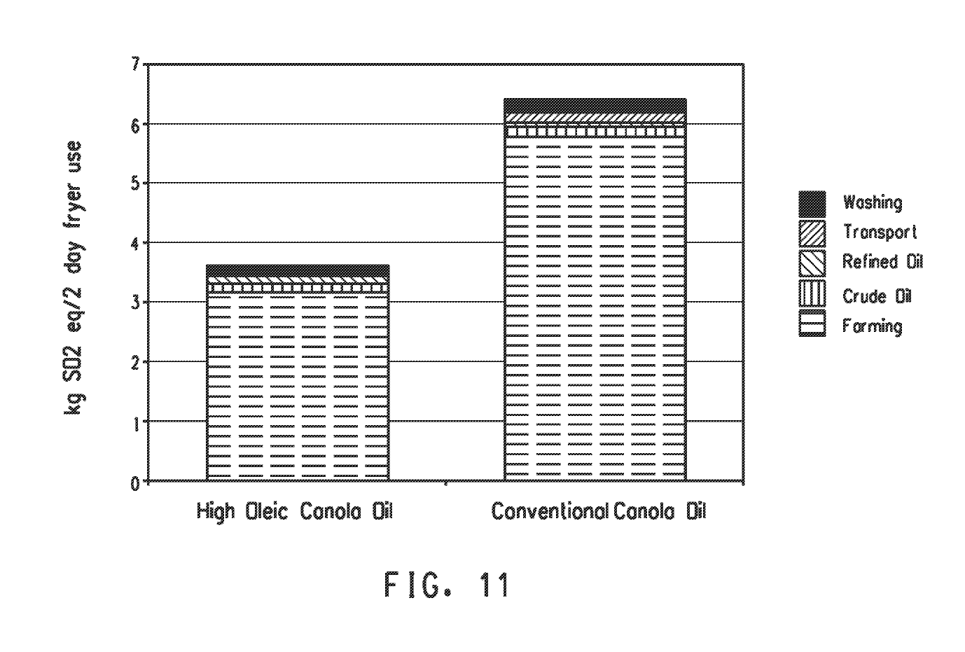

The terrestrial acidification potential results for 2 days of fryer use for conventional canola oil compared to high oleic canola oil are shown in FIG. 11. As shown in FIG. 3 for soy oil, the base case for high oleic canola oil was about 44% lower than the base case for conventional canola oil.

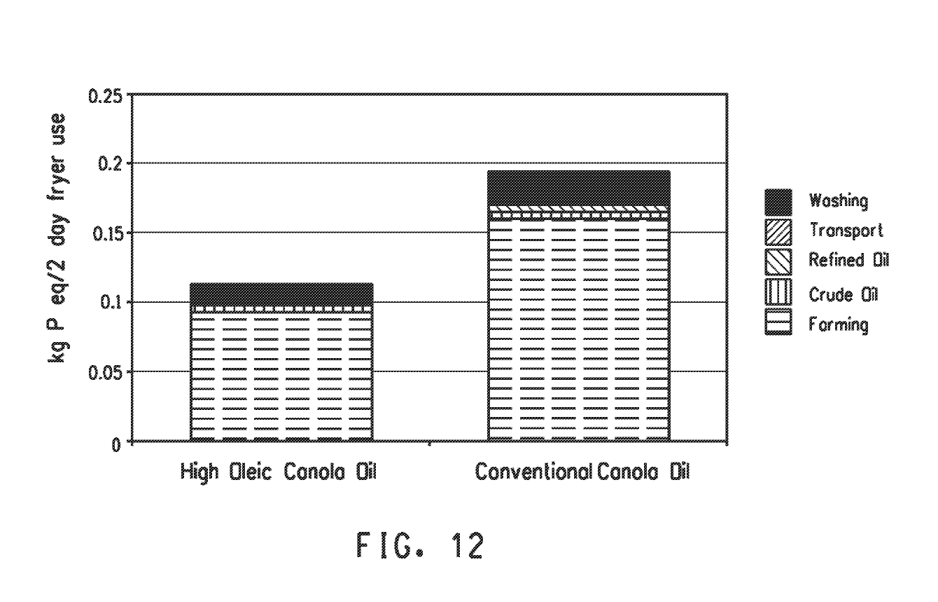

The results for freshwater eutrophication potential for 2 days of frying for conventional canola oil compared to high oleic canola oil are shown in FIG. 12. As shown in FIG. 4 for soy oil, the high oleic canola oil base case was about 43% lower in freshwater eutrophication potential than the conventional canola oil base case.

1.-5. (canceled)

6. A method for assessing the impact of an oil on the environment, the method comprising:
a) frying with an oil having an increased oleic acid content;
b) frying with a comparable oil not having an increased oleic acid content; and
c) quantifying the impact of the oils of steps (a) and (b) on the environment, wherein the oil having an increased oleic acid content has a reduced impact on the environment compared with the comparable oil of step (b).

7. The method of claim 6, wherein the reduced impact on the environment is selected from the group consisting of reduced carbon footprint, reduced eutrophication potential, reduced air acidification potential, reduced non-renewable energy consumption, and a combination thereof.

8. The method of claim 6, wherein the oil having an increased oleic acid content is obtained from a high oleic oilseed.

9. The method of claim 8, wherein the oilseed is selected from the group consisting of soybean, palm, peanut, canola, sunflower, corn, flax, cotton, and safflower.

10. The method of claim 6, wherein the oleic acid content of the oil having increased oleic acid content comprises at least 60% of the fatty acid moieties in the oil.

11.-13. (canceled)

14. The method of claim 6, wherein the oil having an increased oleic acid content of step (a) comprises a high oleic acid oil blended with an ordinary oil.

15. (canceled)

16. A method for quantifying the impact of an oil on the environment, the method comprising
a) heating an oil having an increased oleic acid content to a frying temperature;
b) heating a comparable oil not having an increased oleic acid content to a frying temperature; and
c) quantifying the impact of the oils of steps (a) and (b) on the environment, wherein the oil having an increased oleic acid content has a reduced impact on the environment compared with the comparable oil of step (b).

17. The method of claim 16, wherein the reduced impact on the environment is selected from the group consisting of reduced carbon footprint, reduced eutrophication potential, reduced air acidification potential, reduced non-renewable energy consumption, and a combination thereof.

18. The method of claim 16, wherein the oil having an increased oleic acid content is obtained from a high oleic oilseed.

19. The method of claim 18, wherein the oilseed is selected from the group consisting of soybean, palm, peanut, canola, sunflower, corn, flax, cotton, and safflower.

20. The method of claim 16, wherein the oleic acid content of the oil having increased oleic acid content comprises at least 60% of the fatty acid moieties in the oil.

21. The method of claim 16, wherein the oil having an increased oleic acid content of step (a) comprises a high oleic acid oil blended with an ordinary oil.
